(19) United States
(12) Patent Application Publication
(10) Pub. No.: US 2011/0183751 A1
(43) Pub. Date: Jul. 28, 2011

(54) IMAGING DEVICE, ONLINE GAME SYSTEM, OPERATION OBJECT, INPUT METHOD, IMAGE ANALYSIS DEVICE, IMAGE ANALYSIS METHOD, AND RECORDING MEDIUM

(76) Inventor: Hiromu Ueshima, Shiga (JP)

(21) Appl. No.: 12/863,764

(22) PCT Filed: Jan. 22, 2009
(86) PCT No.: PCT/JP2009/000245

§ 371 Date: Feb. 11, 2011

(30) Foreign Application Priority Data
Jan. 22, 2008 (JP) 2008-011320

(51) Int. Cl. A63F 13/00; H04N 5/225; A63F 13/06

(52) U.S. Cl. 463/30; 348/207.1; 463/40; 348/E05.024

(57) ABSTRACT

The infrared light emitting diodes 11 intermittently emit infrared light. The infrared light are retroreflected by the retroreflection sheet 4 of the operation article 3-N, and it is input into the image sensor 21. The image sensor 21 generates the differential image between the image of the emitting period and the image of the non-emitting period. And the MCU 23 analyzes the differential image and detects the movement of the operation article 3-N and transmits the detection result (the trigger, the position, the area) to the terminal 5. The terminal 5-N uses the detection result received for the online game processing and transmits it to host computer 31.

### TECHNICAL FIELD

The present invention relates to an imaging apparatus which is disposed separately from a computer and is connected to a computer in use, and also relates to its related arts.

### DESCRIPTION OF THE RELATED ARTS

Patent Document 1 discloses an online virtual-reality tennis game system using a camera as an input device. In this system, a camera photographs a player, and a computer main body analyzes an image which is provided from the camera and detects a swing of a player as an input. And the computer main body generates a return data depending on the detected swing.
Patent Document 1: Japanese Unexamined Patent Application 2005-253871

### BRIEF SUMMARY OF THE INVENTION

### The Problem that Invention is Going to Solve

In this way, what a camera transmits to a computer main body is not an input information but an image itself. Therefore, when a game programmer uses a camera as an input device, the game programmer has to produce not only an application program for controlling a game process, but also an program for analyzing an image. Consequently, the camera is very hard for the game programmer to use as an input device for a computer main body.

It is therefore an object of the present invention to provide an imaging apparatus and the related arts thereof that is easy for a programmer of a computer main body to use as an input device.

### Solution of the Problem

According to the first aspect of the present invention, an imaging apparatus disposed separately from a computer, comprising: an imaging unit operable to photograph an operation article operated by a user; an detecting unit operable to analyze a photographed image given from the imaging unit, detect an input from the operation article, and generate an input information; and an transmitting unit operable to transmit the input information to the computer.

In accordance with this configuration, what the imaging apparatus transmits to the computer is not the photographed image, but the input information by the operation article as an analysis result of the photographed image, namely, the input information by the user. Therefore, when a game programmer uses the imaging apparatus as an input device, he does not have to make a program for analyzing the photographed image, and he can treat the imaging apparatus like general input devices, e.g. keyboard etc. As a result, it is possible to provide the imaging apparatus which is easy for a game programmer to use as an input device. Furthermore, it is easily possible to provide an online-game using a dynamic motion, for example a motion of an operation article in three dimensional space, as an input (motion-sensing online game).

In the imaging apparatus, wherein the detecting unit analyzes the photographed image, calculates state information of the operation article, and gives the state information to the transmitting unit as the input information.

In accordance with this configuration, the computer can perform a process based on the state information of the operation article.

In the imaging apparatus, wherein the state information of the operation article means position information, speed information, movement direction information, movement distance information, speed vector information, acceleration information, movement locus information, area information, tilt information, movement information, form information or an combination thereof.

Incidentally, in the present specification, the form includes shape, design, color or an combination thereof. In addition, the form also includes number, symbol and letter.

In the imaging apparatus, wherein the state information of the operation article is the state information of one or a plurality of markers attached to the operation article.

In this case, the state information of a plurality of the markers includes: the state information of each marker; the information showing positional relation between the markers (arrangement information), and number information of the markers; and information about the form of whole of the markers (form information, position information, speed information, movement direction information, movement distance information, speed vector information, acceleration information, movement locus information, area information, tilt information and movement information of such form).

In the imaging apparatus, wherein the transmitting unit transmits the state information to the computer as a command.

In accordance with this configuration, the computer can perform a process in response to the command of the imaging apparatus which is corresponding to the state information of the operation article.

In the imaging apparatus further comprising a stroboscope operable to emit light at predetermined intervals, wherein the imaging unit photographs the operation article each in an emitting period and an non-emitting period of the stroboscope, and further comprising a differential signal generating unit operable to get the images of both of the emitting period and the non-emitting period, and generate a differential signal.

In accordance with this configuration, it is possible to reduce effect of noise or disturbance as much as possible and detect the operation article with a high degree of accuracy, with an easy process, that is, process for generating the differential of the image of the emitting period and the image of the non-emitting period.

In the imaging apparatus, wherein the operation article includes a retroreflection unit operable to retroreflect the light received.

In accordance with this configuration, it is possible to detect the operation article more accurately.

In accordance with a second aspect of the present invention, an online-game system, comprising: a plurality of imaging apparatus each of which is connected to a corresponding terminal and is disposed separately from the terminal, comprising: an imaging unit operable to photograph an operation article operated by a user; an detecting unit operable to analyze a photographed image given from the imaging unit, detect an input from the operation article, and generate an input information; and a transmitting unit operable to transmit the input information to the terminal, and a plurality of the terminals are connected each other via a network, and perform game by exchanging the input information each other.

Therefore, when a game programmer uses the imaging apparatus as an input device, he does not have to make a program for analyzing the photographed image, and he can treat the imaging apparatus like general input devices, e.g. keyboard etc. As a result, it is possible to provide the imaging apparatus which is easy for a game programmer to use as an input device. Furthermore, it is easily possible to provide an online-game using a dynamic motion, for example a motion of an operation article in three dimensional space, as an input. (motion-sensing online game)

In accordance with a third aspect of the present invention, an operation article as a subject of the imaging apparatus operable to be held and moved by a user, comprising: a plurality of retroreflection units; a switching unit which switches an exposure state and a non-exposure state in regard to at least one of the reflection unit; and wherein at least one of the reflection unit keep the exposure state.

In accordance with this configuration, it is always possible to detect the input and/or the input-type by the operation article on the basis of the photographed image of the reflection unit because one of the reflection units always keep the exposure state.

In addition, one of the reflection units can change the exposure state and the non-exposure state, so it is possible to give different inputs according to whether such reflection unit is photographed or not. As a result, the input type using the reflection unit becomes diverse.

In accordance with a fourth aspect of the present invention, an operation article as a subject of the imaging apparatus operable to be held and moved by a user, comprising: a first reflection unit; a second reflection unit; and a switching unit operable to switch states of the first reflection unit and the second reflection unit so that an exposure state and non-exposure state become opposite state by and between the first reflection unit and the second reflection unit.

In accordance with this configuration, the exposure state and the non-exposure state of the first reflection unit and the second reflection unit become opposite each other, so it is possible to detect the input and/or the input type by the operation article, on the basis of the photographed images of each reflection unit.

In the operation article of the third and fourth aspect of the present invention, wherein the reflection unit retroreflect the light received.

In accordance with a fifth aspect of the present invention, an input method performed by an imaging apparatus which is disposed separately from a computer, comprising the steps of: photographing an operation article operated by a user; analyzing an image which is given by the step of photographing, detecting input from the operation article, and generating input information; transmitting the input information to the computer.

In accordance with this configuration, similar advantage as the imaging apparatus according to the above first aspect can be gotten.

In accordance with a sixth aspect of the present invention, a computer-readable recording medium records a computer program which makes a computer of a imaging apparatus perform the input method of the fifth aspect of the present invention.

In accordance with this configuration, similar advantage as the imaging apparatus according to the above first aspect can be gotten.

In accordance with a seventh aspect of the present invention, an image analyzing apparatus, comprising: an imaging unit operable to photograph one or a plurality of subjects; a first potential area determining unit operable to determine, from the photographed image by the imaging unit, a first potential area which includes image of the subject and is comprised of fewer pixels than pixels of the photographed image; a first state calculating unit operable to scan the first potential area and calculate the state information of the subject, in the case where the number of the subject is one or two; a second potential area determining unit operable to determine, from the first potential area, a second potential area which includes the image of the subject and is comprised of fewer pixels than pixels of the first potential area, in the case where the number of the subject is at least three; and a second potential area determining unit operable to scan the second potential area and calculate the state information of the subject, in the case where the number of the subject is at least three.

In accordance with this configuration, it is possible to calculate the state information even though the number of the subject exceeds three, on the other hand, in the case where the number of the subject is one or two, it is possible to skip the processes of the second potential area determining unit and the second state information calculating unit, that is, it is possible to reduce processing load.

In above description, the term of “include” means that: the image of the subject is completely in the first potential area and does not protrude; or the image of the subject is completely in the second potential area and does not protrude.

In this image analyzing apparatus, wherein the first potential area determining unit comprising: a first arranging unit operable to generate a first array which is the orthographic projection to the horizontal axis of a pixel value of the image; a second arranging unit operable to generate a second array which is the orthographic projection to the vertical axis of the pixel value of the image; and an unit operable to determine the first potential area based on the first array and the second array, and wherein the second potential area determining unit comprising: a third arranging unit operable to generate a third array which is the orthographic projection to the horizontal axis of the pixel value of the first potential area; a fourth arranging unit operable to generate a fourth array which is the orthographic projection to the vertical axis of the pixel value of the first potential area; and a unit operable to determine the second potential area based on the third array and the fourth array.

In this image analyzing apparatus, further comprising a stroboscope operable to emit light to the operation article at predetermined intervals, wherein the imaging unit, comprising a differential signal generating unit operable to photograph the operation article each in an emitting period and an non-emitting period of the stroboscope and get the images of both of the emitting period and the non-emitting period, and generate a differential signal, and wherein the first potential area determining unit, the first state information calculating unit, the second potential area determining unit and the second state information calculating unit perform processes on the basis of the differential signal.

In accordance with this configuration, it is possible to reduce effect of noise or disturbance as much as possible and detect the operation article with a high degree of accuracy, with an easy process, that is, process for generating the differential of the image of the emitting period and the image of the non-emitting period.

In accordance with a eighth aspect of the present invention, an image analyzing method is based on a photographed image given by an imaging unit photographing one or a plurality of subjects, and comprising the steps of; detecting, from the photographed image, a first potential area which includes image of the subject and is comprised of fewer pixels than pixels of the photographed image; scanning the first potential area and calculating a state information of the subject, in the case where the number of the subject is one or two; detecting, from the first potential area, a second potential area which includes the image of the subject and is comprised of fewer pixels than pixels of the first potential area, in the case where the number of the subject is at least three; and scanning the second potential area and calculating the state information of the subject, in the case where the number of the subject is at least three.

In accordance with this configuration, similar advantage as the imaging apparatus according to the above seventh aspect can be gotten.

In accordance with a ninth aspect of the present invention, a computer-readable recording medium records a computer program which makes a computer of a imaging apparatus perform the image analyzing method of the eighth aspect of the present invention.

In accordance with this configuration, similar advantage as the imaging apparatus according to the above seventh aspect can be gotten.

Incidentally in a range of an instant specification and the request the recording medium, for example, a flexible disk, a hard disk, a magnetic tape, an MO disk, a CD (CD)—I include ROM), DVD (including DVD-Video, DVD-ROM, DVD-RAM) including Video-CD, an ROM cartridge, RAM memory cartridge with battery backup, a flash memory cartridge, a nonvolatile RAM cartridge.

### BRIEF DESCRIPTION OF THE FIGURES

The novel features of the invention are set forth in the appended claims. The invention itself, however, as well as other features and advantages thereof, will be best understood by reading the detailed description of specific embodiments in conjunction with the accompanying drawings, wherein:

FIG. 1 is an appearance perspective view showing the overall structure of the game system in accordance with the embodiment of this invention.

FIG. 2 is a view showing an electrical structure of the camera unit 1-N of the FIG. 1.

FIG. 3A is an appearance perspective view of the operation article 3A-N of FIG. 1. FIG. 3B is an appearance perspective view of another example of the operation article. FIG. 3C is an appearance perspective view of a further example of the operation article.

FIG. 4 is an explanatory view of a detecting process to detect retroreflection sheets 4 based on a differential image “DI” which the image sensor 21 outputs.

FIG. 5 is an explanatory view of an additional detecting process to detect the retroreflection sheets 4 in the case where a player uses the operation article 3C-N.

FIG. 6 is an explanatory view of a tilt detecting process to detect tilt of the operation article 3A-N.

FIG. 7 is an explanatory view of a swing detection process to detect a swing of the operation article 3A-N.

FIG. 8 is an explanatory view of a swing direction of the operation article 3A-N.

FIG. 9 is an explanatory view of a swing position of the operation article 3A-N.

FIG. 10 is an explanatory view of a special operation by the operation article 3A-N.

FIG. 11 is an explanatory view of a special trigger based on the operation article 3B-N.

FIG. 12 is an explanatory view of various triggers based on the operation article 3C-N.

FIG. 13 is another example of the operation article 3C-N of FIG. 3C.

FIG. 14 is a flowchart showing an overall process flow of the MCU 23 of FIG. 2.

FIG. 15 is a flowchart showing a flow of the photographing process in step S3 of FIG. 14.

FIG. 16 is a flowchart showing a part of the detecting process of the retroreflection sheets in step S5 of FIG. 14.

FIG. 17 is a flowchart showing another part of the photographing process of the retroreflection sheets in step S5 of FIG. 14.

FIG. 18 is a flowchart showing still other part of the photographing process of the retroreflection sheets in step S5 of FIG. 14.

FIG. 19 is a flowchart showing still other part of the photographing process of the retroreflection sheets in step S5 of FIG. 14.

FIG. 20 is a flowchart showing still other part of the detecting process of the retroreflection sheets in step S5 of FIG. 14.

FIG. 21 is a flowchart showing still other part of the detecting process of the retroreflection sheets in step S5 of FIG. 14.

FIG. 22 is a flowchart showing still other part of the detecting process of the retroreflection sheets in step S5 of FIG. 14.

FIG. 23 is a flowchart showing the four end points detecting process in step S349 of FIG. 21.

FIG. 24 is a flowchart showing the trigger detecting process (based on the sword) in step S9 of FIG. 14.

FIG. 25 is a flowchart showing the shield trigger detecting process in step S443 of FIG. 24.

FIG. 26 is a flowchart showing the special trigger detecting process in step S445 of FIG. 24.

FIG. 27 is a flowchart showing another special trigger detecting process in step S445 of FIG. 24.

FIG. 28 is a flowchart showing the swing trigger detecting process in step S447 of FIG. 24.

FIG. 29 is a flowchart showing a part of the trigger detecting processing (based on the Mace) in step S9 of FIG. 14.

FIG. 30 is a flowchart showing another part of the trigger detecting process (based on the Mace) of step S9 of FIG. 14.

FIG. 31 is a flowchart showing a part of the trigger detecting process (based on the crossbow) in step S9 of FIG. 14.

FIG. 32 is a flowchart showing the charge trigger detecting process in step S765 of FIG. 31.

FIG. 33 is a flowchart showing the shield trigger detecting process in step 769 of FIG. 31.

FIG. 34 is a flowchart showing the switch trigger detecting process in step 771 of FIG. 31.

FIG. 35 is a flowchart showing the shooting trigger detecting process in step S777 of FIG. 31.

### EXPLANATION OF REFERENCES

1-N (1-1 to 1-n) . . . camera unit, 3-N (3-1 to 3-n), 3A-N (3A-1 to 3A-n), 3B-N (3B-1 to 3B-n), 3C-N (3C-1 to 3C-n) . . . operation article, 5-N (5-1 to 5-n) . . . terminal, 4, 4A to 4G . . . retroreflection sheet(s), 11 . . . infrared emitting diode(s), 21 . . . image sensor, 23 . . . MCU, 29 . . . network, 31 . . . host computer

### DESCRIPTION OF THE PREFERRED EMBODIMENTS

In what follows, an embodiment of the present invention will be explained in conjunction with the accompanying drawings. Meanwhile, like references indicate the same or functionally similar elements throughout the drawings, and therefore redundant explanation is not repeated.

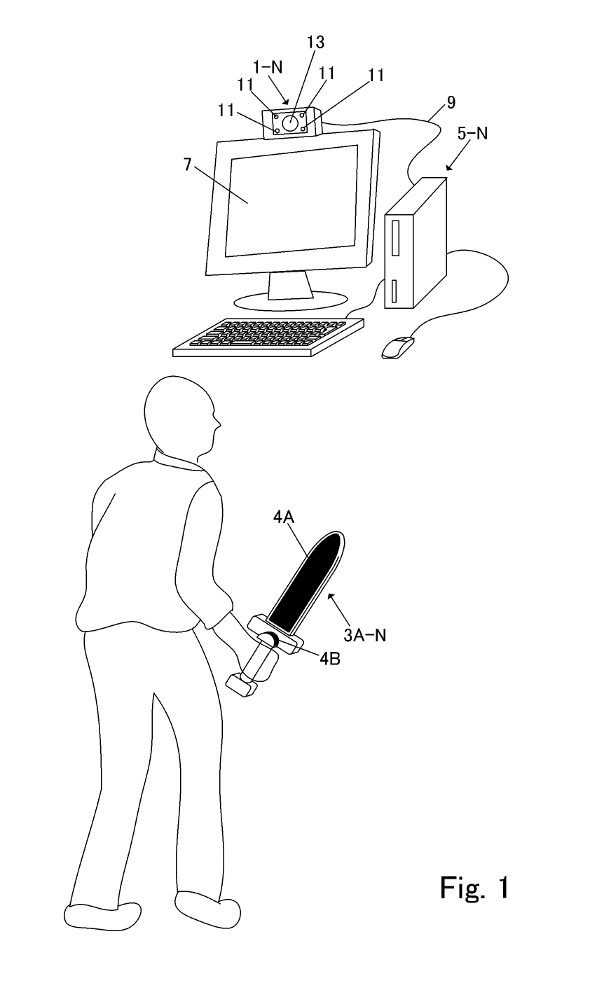

FIG. 1 is an appearance perspective view showing the overall structure of the game system in accordance with the embodiment of this invention. Referring to FIG. 1, the game system includes: the sword-shaped operation article 3A-N (hereinafter referring to as “sword”) which a player holds and moves; the terminal 5-N; and the camera unit 1-N which is set on the upper edge of the television monitor 7. Incidentally, “N” is an integer number of one or more.

The camera unit 1-N is connected to the terminal 5-N by USB (Universal Serial Bus) cable 9. The camera unit 1-N comprises: the infrared filter 13 operable to transmit only infrared light; and four infrared emitting diodes (IRED) operable to emit infrared light, located around the infrared filter 13. An image sensor 21 to be described below is located behind the infrared filter 13.

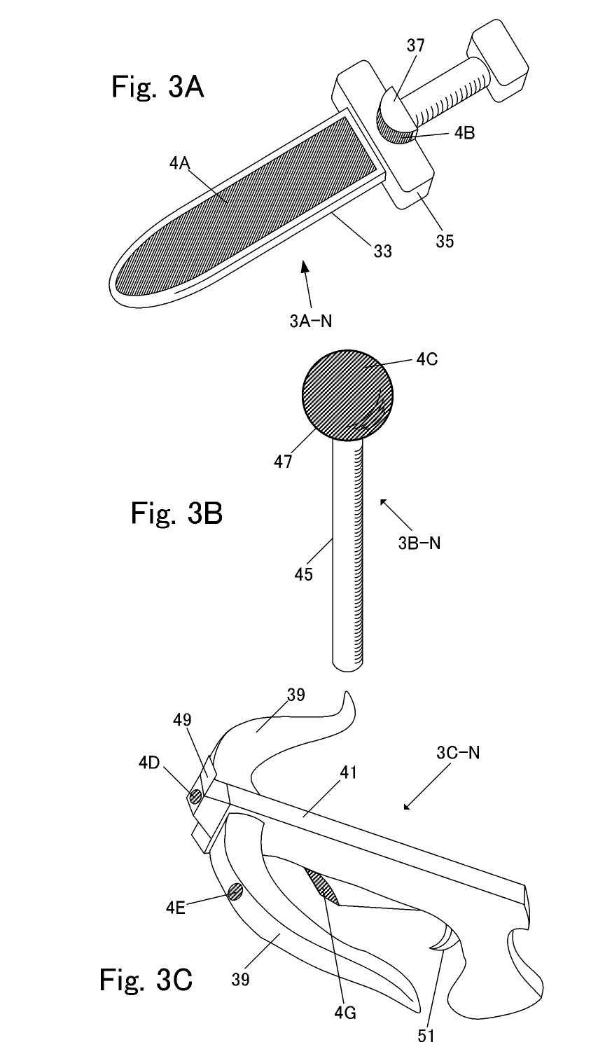

As shown in FIG. 3A, retroreflection sheets 4A are attached on both sides of the blade 33 of the sword 3A-N. And, semicylinder-shaped components 37 are attached on both sides of a brim 35 of the sword 3A-N. And retroreflection sheets 4B are attached on a curved surfaces of these semicylinder-shaped components 37.

In the present embodiment, there are two operation article other than the sword 3A-N. FIG. 3B shows a mace-shaped operation article (hereinafter referring to as “Mace”) 3B-N. The mace 3B-N includes a stick 45 held by a player, and ball 27 which is fixed at one end of the stick 47. The whole surface of the ball 47 is covered with a retroreflection sheet 4C.

FIG. 3C shows a crossbow-shaped operation article (hereinafter referred to as “crossbow”) 3C-N. Circular retroreflection sheets 4E and 4F (not shown in the figure) are symmetrically attached on the left and right side of a bow component 39. A circular retroreflection sheet 4D is attached between the right and left retroreflection sheets 4E and 4F, and at the tip of a pedestal 41.

In addition, a cover 49 is freely openably/closably attached to the tip of the pedestal 41.

While a trigger 51 is not pulled, the cover 49 keeps closed. Therefore, in this case, the retroreflection sheet 4D is hidden by the cover 49 and is not exposed. On the other hand, while the trigger 51 is pulled, the cover 49 keeps open as shown in the figure. Therefore, in this case, the retroreflection sheet 4D is exposed.

Furthermore, there is a retroreflection sheet 4G on the bottom of the pedestal 41. The retroreflection sheet 4G is attached so that the reflective surface thereof forms the acute angle (in relation to the trigger 51) to the lengthwise direction of the pedestal 41. Therefore, the retroreflection sheet 4G is not photographed while the pedestal 41 turns to the camera unit 1, and the retroreflection sheet 4G is photographed while the tip of the pedestal 41 turns obliquely upward.

The retroreflection sheets 4A to 4G may be comprehensively referred to as the “retroreflection sheets 4”. The retroreflection sheets 4 may be referred to as the markers 4.

In addition, the sword 3A-N, the mace 3B-N and the crossbow 3C-N may be comprehensively referred to as the operation article 3-N. The operation article 3-N may be referred as to subject 3-N.

Returning to FIG. 1, the infrared emitting diodes 11 of the camera unit 1-N emit infrared light intermittently at predetermined intervals. In this way, the infrared emitting diodes 11 function as a stroboscope. The infrared light from the infrared emitting diodes 11 are retroreflected by the retroreflection sheets 4A or 4B of sword 3A-N, and is input into the image sensor 21 which is behind of the infrared filter 13. In this way, the sword 3A-N is photographed intermittently. The similar process is applied to the mace 3B-N and the crossbow 3C-N.

However, the image sensor 21 performs the photographing process also in a non-emission period of the infrared light. Therefore, the camera unit 1 calculates a differential signal “DI” (differential picture “DI”) between the image of a emitting period and the image of a non-emitting period, then detects the movement of the sword 3A-N on the basis of this differential signal “DI”, and then transmits a result of the detection to the terminal 5-N by USB cable 9. And the terminal 5-N uses the movement of the sword 3A-N in the online game process. The similar process is applied to the mace 3B-N and the crossbow 3C-N.

Incidentally, by calculating the differential signal “DI”, the camera unit 1 can remove noise of light other than the light reflected from the retroreflection sheets 4 as much as possible, and can detect the retroreflection sheets 4 with high accuracy.

Each participant of the online game (player) owns the game system of the FIG. 1.

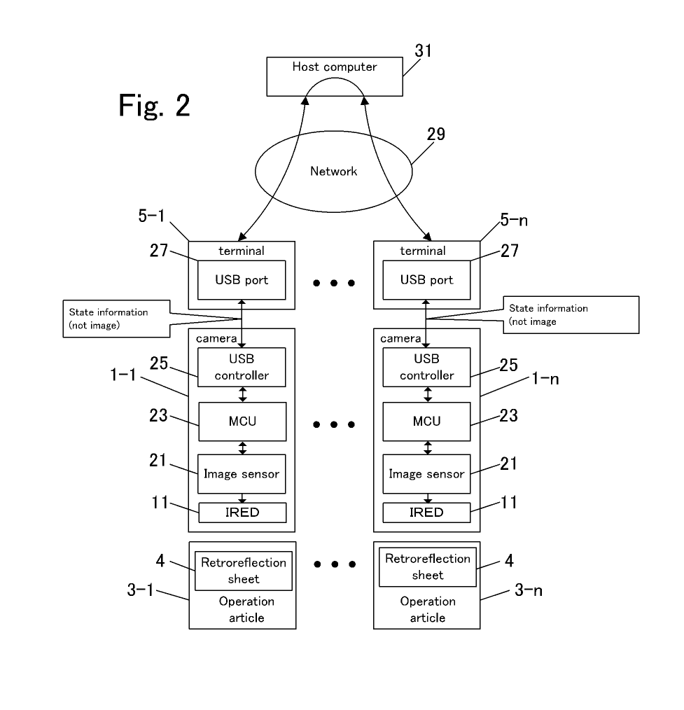

Referring to FIG. 2, in the present embodiment, a host computer 31 provides online game to each of the terminals 5-1 to 5-n via network 29. Each terminal 5-1 to 5-n is respectively connected to the camera unit 1-1 to 1-n. Each camera unit 1-1 to 1-n respectively photographs the retroreflection sheets 4 of the operation article 3-1 to 3-n. The terminal 5-N of FIG. 1 is what the terminals 5-1 to 5-n are comprehensively referred to as. The camera unit 1-N of FIG. 1 is what the camera units 5-1 to 5-n are comprehensively referred to as. The operation article 3-N (3A-N, 3B-N and 3C-N) of each FIG. 3A, FIG. 3B and FIG. 3C is what the operation articles 3-1 to 3-n are comprehensively referred to as.

By the way, the camera unit 1-N includes a USB controller 25, a MCU (Micro Controller Unit) 23, the image sensor 21 and the infrared emitting diodes (IRED) 11.

The USB controller 25 is controlled by the MCU23, communicates with the terminal 5-N through the USB cable 9 and a USB port 27 of the terminal 5-N, and transmits and receives data. The image sensor 21 is controlled by MCU23, and performs photographing process each in the emitting period and the non-emitting period of the infrared emitting diodes 11. Then, the image sensor 21 outputs the differential signal “DI” which is the differential signal between the image signal of the emitting period and the image signal of the non-emitting period. In addition, the image sensor 21 turns on the infrared emitting diodes 11 intermittently. Incidentally, for example in the present embodiment, the resolution of the image sensor 21 is 64 pixels×64 pixels.

The MCU 23, on the basis of the differential signal “DI” which is given from the image sensor 21, detects the images of the retroreflection sheets 4 and calculates the state information thereof.

The state information is the information of the retroreflection sheets 4, namely position information, speed information, movement direction information, movement distance information, speed vector information, acceleration information, movement locus information, area information, tilt information, movement information, form information or an combination thereof. The form includes shape, design, color or combination thereof. In addition, the form includes number, symbol and letter. Furthermore, the state information of the retroreflection sheets 4 includes: the state information of each retroreflection sheet 4; the information showing positional relation of the retroreflection sheets 4, and number information of the retroreflection sheets 4; and form information, position information, speed information, movement direction information, movement distance information, speed vector information, acceleration information, movement locus information, area information, tilt information and movement information of the form which is formed by whole of the retroreflection sheets 4.

In what follows, the embodiment of the present invention will be explained in conjunction with the specific examples.

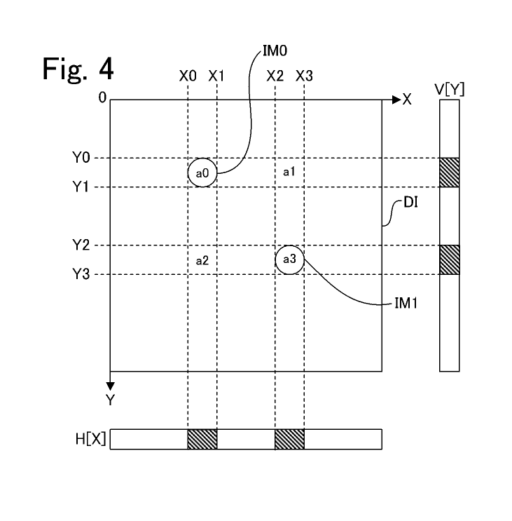

FIG. 4 is an explanatory view of a detection process of the retroreflection sheets 4 based on the differential image (differential signal) “DI” which the image sensor 21 outputs. Referring to FIG. 4, the MCU23 scans a column, incrementing “Y” one by one from (X, Y)=(0, 0), until the MCU 23 compares the brightness of each pixel (hereinafter referred to as “pixel value”) with the predetermined threshold value “Thl” and detects the pixel whose pixel value exceeds a predetermined threshold value “Thl”, or until “Y” becomes “63”.

When the MCU 23 finishes scanning the column, the MCU 23 sets “Y” to “0” and increments “X”, then the MCU 23 scans next column, incrementing “Y” one by one, until the MCU 23 compares the pixel value with the predetermined threshold value “Thl” and detects the pixel whose pixel value exceeds a predetermined threshold value “Thl”, or until “Y” becomes “63”.
The MCU 23 scans the pixels of each column of the differential image “DI” by executing such a process.

In this scanning, when the MCU 23 detects, in a certain column, the pixel whose pixel value is not more than the threshold value “Thl” and detects, in the next column, the pixel whose pixel value exceeds the threshold value “Thl”, the MCU 23 stores the X-coordinate of such pixel (In FIG. 4, X0 and X2) in its internal memory (not shown in the figure).

And when the MCU 23 detects, in a certain column, the pixel whose pixel value exceeds the threshold value “Thl”, and detects, in the next column, the pixel whose pixel value is not more than the threshold value “Thl”, the MCU 23 stores the X-coordinate of the pixel which is included in the left column of such pixel (In FIG. 4, X1 and X3) in the internal memory.

Next, the MCU23 scans a row, incrementing “X” one by one from (X, Y)=(0, 0), until the MCU 23 compares the pixel value with the threshold value “Thl” and detects the pixel whose pixel value exceeds the threshold value “Thl”, or until “X” becomes “63”.

When the MCU 23 finishes scanning the row, the MCU 23 sets “X” to “0” and increments “Y”, then the MCU 23 scans next row, incrementing “X” one by one, until the MCU 23 compares the pixel value with the predetermined threshold value “Thl” and detects the pixel whose pixel value exceeds a predetermined threshold value “Thl”, or until “X” becomes “63”.
The MCU 23 scans the pixels of each row of the differential image “DI” by executing such a process.

In this scanning, when the MCU 23 detects, in a certain row, the pixel whose pixel value is not more than the threshold value “Thl” and detects, in the next row, the pixel whose pixel value exceeds the threshold value “Thl”, the MCU 23 stores the Y-coordinate of such pixel (In FIG. 4, Y0 and Y2) in the internal memory.

And when the MCU 23 detects, in a certain row, the pixel whose pixel value exceeds the threshold value “Thl”, and detects, in the next row, the pixel whose pixel value is not more than the threshold value “Thl”, the MCU 23 stores the Y-coordinate of the pixel which is included in the upper next row of such pixel (In FIG. 4, Y1 and Y3) in the internal memory.

At this point, the MCU23 can recognize that an image “IM0” and an image “IM1” exist in one of four potential areas: a potential area “a0” surrounded by a line “X=X0”, “X=X1”, “Y=Y0” and “Y=Y1”; a potential area “a1” surrounded by a line “X=X2”, “X=X3”, “Y=Y0” and “Y=Y1”; a potential area “a2” surrounded by a line “X=X0”, “X=X1”, “Y=Y2” and “Y=Y3”; or a potential area “a3” surrounded by a line “X=X2”, “X=X3”, “Y=Y2” and “Y=Y3”. However, at this point, the MCU 23 cannot determine in which of the potential areas “a0” to “a3” the images “IM0” and “IM1” exist.

So, the MCU23 compares the pixel value with the threshold value “Thl” in each of the potential areas “a0” to “a3”, and determines that the images “IM0” and “IM1” exist in the potential area which includes the pixel whose pixel value exceeds the threshold value “Thl”.

In FIG. 4, the MCU 23 determines that the images “IM0” and “IM1” respectively exist in the potential area “a0” and “a3”. The MCU 23 recognises the number of the potential areas which include the pixel exceeding the threshold value “Thl” as the number of the images.

And the MCU 23 calculates the XY-coordinate of the images “IM0” and “IM1” by the “Formula 1”, with respect to each of the potential areas “a0” and “a3” which the MCU 23 determined that the images “IM0” and “IM1” existed in.

$$Xr = \frac{( {\sum }_{j} ( Pj \times Xj ) ) \times R}{{\sum }_{j} Pj} \\ Yr = \frac{( {\sum }_{j} ( Pj \times Yj ) ) \times R}{{\sum }_{j} Pj} \qquad [ Formula 1 ]$$

“Pj” is a pixel value of the potential area in which the retroreflection sheets 4 exist, and “Xj” is the X-coordinate of the pixel value “Pj”, and “Yj” is the Y-coordinate of the pixel value “Pj”, and, the subscript “j” means the pixel of the potential area in which the retroreflection sheets 4 exist.

“R” is a constant prescribing the resolution. If the resolution of the image sensor 21 were 64 pixels×64 pixels, and in the case of “R”=8, the resolution in which the calculated XY-coordinate (Xr, Yr) is placed would become 512 pixels×512 pixels. Incidentally, the MCU23 considers the pixel value “Pj” less than the threshold value “Thl” as “0”, in the calculation. Incidentally, the MCU 23 may ignore the pixel value “Pj” which is not more than the threshold value “Thl”, and calculate the mathematical formula 1 with only the pixel value “Pj” which exceeds the threshold value “Thl”.

The MCU 23 calculates “Formula 1” and counts the number of the pixels which exceed the threshold value “Thl” in each of the potential areas “a0” and “a3” where the images “IM0” and “IM1” exist. In FIG. 4, in the potential area 1, the number of the pixels which exceed the threshold value “Thl” corresponds to the area of the image “IM0”, and in the potential area “a3”, the number of the pixels which exceed the threshold value “Thl” corresponds to the area of the image “IM1”.

Because the retroreflection sheets 4 retroreflect the infrared light, the area of the pixels which exceed the threshold value “Thl”, that is the images “IM0” and “IM1”, corresponds to the retroreflection sheets 4. In FIG. 4, two pieces of the retroreflection sheets 4 are photographed.

As described above, the MCU 23 calculates the XY-coordinate and the area of the images “IM0” and “IM1” of the retroreflection sheets 4.

Next is about another calculating method for the potential areas “a0” to “a3”. Incidentally, the potential areas are detected by this method, in the following flowchart.

There are arrays H[X] and V[Y].

### X=“0” to “63”, and Y=“0” to “63”.

In FIG. 4, the array H[X] and V[Y] are expressed schematically respectively by rectangles. The MCU 23 scans the row from (X, Y)=(0,0) to X=“63” incrementing X one by one. When the MCU 23 finishes scanning in the row, the MCU23 sets “X” to “0”, increments “Y”, and then the MCU 23 again scans the next row with incrementing “X” one by one, until “X” becomes “63”. The MCU 23 scans the pixels of each row of the differential image “DI” by executing such a process.

In this scanning, the MCU 23 substitutes “1” for the array H[X] and V[Y] corresponding to the XY-coordinate of the pixel more than the threshold value “Thl”.

On the other hand, the MCU 23 substitutes “0” for the array H[X] and V[Y] corresponding to the XY-coordinate of the pixel that is not more than the threshold value “Thl”.
However, in the case where the MCU 23 has already substituted “1” for the array H[X], the MCU 23 keeps such “1”, or in the case where the MCU 23 has already substituted “1” for the array V[Y], the MCU 23 keeps such “1”. FIG. 4 schematically shows the arrays H [X] and V[Y] stored “1”, by hatching.

The leftmost element number “X” of the array H[X] which stores “1” are the X-coordinate “X0” and “X2”. The rightmost element number “X” of the array H[X] which stores “1” are the X-coordinate “X1” and “X3”. The uppermost element number “Y” of the array V[Y] which stores “1” are the Y-coordinate “Y0” and “Y2”. The lowermost element number “Y” of the array V[Y] which stores “1” are the Y-coordinate “Y1” and “Y3” In this way, the potential areas “a0” to “a3” can be determined.

Incidentally, it can be said that the orthographic projection to the horizontal axis (the X-axis) of the pixel value of the differential image is stored in the array H [X]. And it can be said that the orthographic projection to the vertical axis (the Y-axis) of the pixel value of the differential image is stored in the array V [Y].

By the way, even though one or three retroreflection sheets 4 would be photographed in the differential image “DI”, the XY-coordinate and the area of the images of the retroreflection sheets can be calculated in the similar way of the case of two retroreflection sheets. However, in the case where more than three retroreflection sheets 4 might be photographed, that is, in the case where a player uses the crossbow 3C-N, the following processes are added.

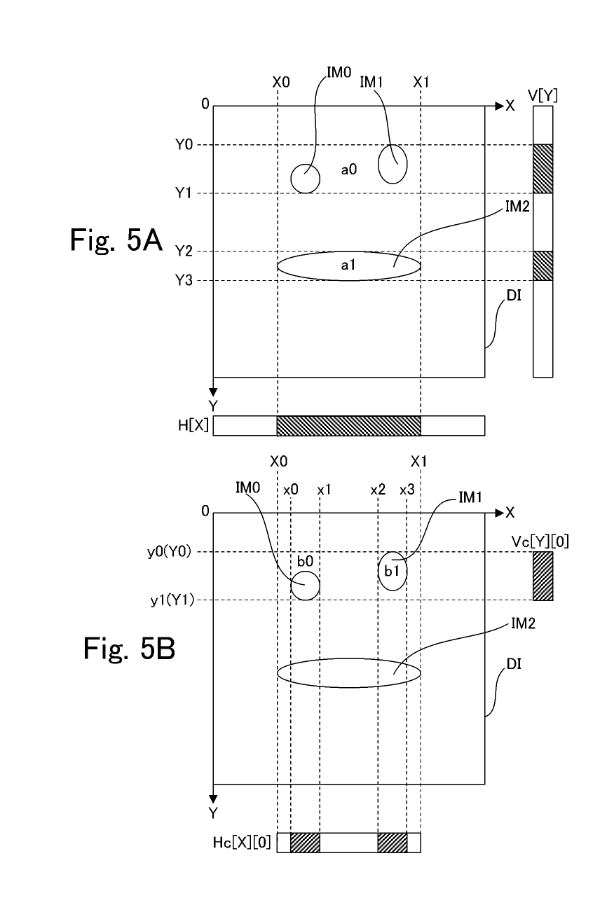

FIG. 5A and FIG. 5B are explanatory view of the additional detecting process of the retroreflection sheets 4 when a player uses the crossbow 3C-N. As shown in FIG. 5A, even though three images “IM0” to “IM2” appear in the differential image “DI”, the above-mentioned detecting process only can detect two potential areas “a0” and “a2”. In this case, the potential area “a0” is the area surrounded by the lines “X=X0”, “X=X1”, “Y=Y0” and “Y=Y1”. And the potential area “a2” is the area surrounded by the lines “X=X0”, “X=X1”, “Y=Y2” and “Y=Y3”. Therefore in this case, the MCU 23 erroneously recognises that number of the images, that is, the retroreflection sheets 4 is two.

Therefore, the MCU 23 performs the detecting process as described above with respect to each of the potential areas “a0” and “a1” in the case where the MCU 23 recognises that photographed retroreflection sheets 4 are two. That is to say, the MCU23 scans the column, incrementing “Y” one by one from (X, Y)=(X0, Y0), until the MCU 23 compares the pixel value with the threshold value “Thl” and detects the pixel whose pixel value exceeds the threshold value “Thl” or “Y” becomes “Y1”.

When the MCU 23 finishes scanning the column, the MCU 23 sets “Y” as “Y0”, and increments “X”, then the MCU 23 scans the next column, incrementing “Y” one by one, until the MCU 23 compares each the pixel value with the predetermined threshold value “Thl” and detects the pixel whose pixel value exceeds a predetermined threshold value “Thl”, or until “Y” becomes “Y1”. The MCU 23 performs such a process until “X=X1”, and scans the pixels of each column of the potential area “a0”.

In this scanning, when the MCU 23 detects the pixel which exceeds the threshold value “Thl” in the column “X=X0”, or when the MCU 23 detects the pixel which is less than the threshold value “Thl” in a certain column and then detects the pixel which exceeds the threshold value “Thl” in the next column, the MCU 23 stores the X-coordinate of such pixel (In FIG. 5B, x0 and x2) in the internal memory. And when the MCU 23 detects the pixel which exceeds the threshold value “Thl” in the column “X=X1”, the MCU 23 stores the X-coordinate of such pixel. And when the MCU 23 detects the pixel which exceeds the threshold value “Thl” in a certain column and then detects the pixel which is less than the threshold value “Thl” in another column, the MCU 23 stores the X-coordinate of the pixel (In FIG. 5B, X1 and X3) which is included in the left column of such pixel in the internal memory.

Next, the MCU23 scans the row, incrementing “X” one by one from (X, Y)=(X0, Y0), until the MCU 23 compares the pixel value with the threshold value “Thl” and detects the pixel whose pixel value exceeds the threshold value “Thl”, or until “X” becomes “X1”. When the MCU 23 finishes scanning the row, the MCU 23 sets “X” as “X0” and increments “Y”, then the MCU 23 scans the next row, incrementing “X” one by one, until the MCU 23 compares the each pixel value with the predetermined threshold value “Thl” and detects the pixel which exceeds the threshold value “Thl”, or until “X” becomes “X1”. The MCU 23 performs such process until “Y=Y1”, and scans the pixels of each row of the potential area “a0”.

In this scanning, when the MCU 23 detects the pixel which exceeds the threshold value “Thl” in the row “Y=Y0”, or when the MCU 23 detects the pixel which is less than the threshold value “Thl” and then detects the pixel which exceeds the threshold value “Thl” in the next row, the MCU 23 stores the Y-coordinate of such pixel (In FIG. 5B, y0) in the internal memory. And when the MCU 23 detects the pixel which exceeds the threshold value “Thl” in the row “Y=Y1”, the MCU 23 stores the Y-coordinate of such pixel. And when the MCU 23 detects the pixel which exceeds the threshold value “Thl” in a certain row and then detects the pixel which is less than the threshold value “Thl” in the next row, the MCU 23 stores the Y-coordinate of the pixel which is included in the next upper row of such pixel in the internal memory.

At this point, as shown in FIG. 5B, the MCU23 can recognize: the potential area “b0” which is surrounded by the line “X=x0”, “X=x1”, “Y=y0” and “Y=y1”; and the potential area “b1” which is surrounded by the line “X=x2”, “X=x3”, “Y=y0” and “Y=y1”.

And the MCU23 compares the pixel value with the threshold value “Thl” in each of the potential areas “b0” and “b1”, and determines that the images “IM0” and “IM1” exist in the potential areas which include the pixel whose pixel value exceeds the threshold value “Thl”. In FIG. 5B, the MCU 23 determines that the images “IM0” and “IM1” respectively exist in the potential areas “b0” and “b1”. The MCU 23 recognizes that the number of the potential areas which include the pixel exceeding the threshold value “Thl” is the number of the image which appears in the potential area “a0” (As shown in FIG. 5A).

Furthermore, the MCU 23 calculates the XY-coordinate (Xr, Yr) of the images “IM0” and “IM1” by the “Formula 1”, with respect to each of the potential areas “b0” and “b1” where the MCU 23 determined that the images “IM0” and “IM1” existed.

The MCU 23 calculates the “Formula 1” and counts the number of the pixels which exceed the threshold value “Thl” in each of the potential areas “b0” and “b1” where there is the images “IM0” and “IM1”. In FIG. 5B, in the potential area “b0”, the number of the pixels that exceeds the threshold value “Thl” corresponds to the area of the image “IM0”, and in the potential area “b1”, the number of the pixels that exceeds the threshold value “Thl” corresponds to the area of the image “IM1”.

The retroreflection sheets 4 reflect the infrared light, therefore the area of the pixel which exceeds the threshold value “Thl”, that is the images “IM0” and “IM1”, correspond to the retroreflection sheets 4. In FIG. 5B, it turns out that two pieces of the retroreflection sheets 4 appear in the potential area “a0”.

In this way, the MCU 23 calculates the XY-coordinate and the area of the images “IM0” and “IM1” of the retroreflection sheets 4.

In addition, the MCU 23, by scanning the area “b0”, calculates the largest X-coordinate “mxX[0]”, the largest Y-coordinate “mxY[0]”, the smallest X-coordinate “mnX[0]” and the smallest Y-coordinate “mnY[0]” of the image “IM0”. In addition, the MCU 23, by scanning the area “b1”, calculates the largest X-coordinate “mxX[1]”, the largest Y-coordinate “mxY[1]”, the smallest X-coordinate “mnX[1]” and the smallest Y-coordinate “mnY[1]” of the image “IM1”.

The MCU23, also in the potential area “a1”, performs the process which is performed in the potential area “a0” of FIG. 5A, for calculating the XY-coordinate and the area of the image “IM2” of the retroreflection sheets 4.

Next is the explanation of another calculation method of the potential areas “b0” and “b1”. Incidentally, in the later flowchart, the potential areas are detected by this method. There are array “HcX[X][0]” and “VcY[Y][0]”. In this case, “X”=“X0” to “X1”, and “Y”=“Y0” to “Y1”. In the FIG. 5B, each of the arrays “HcX[X][0]” and “VcY[Y][0]” are expressed schematically by a rectangle. The MCU 23 scans the row from (X, Y)=(X0, Y0) to “X=X1”, incrementing “X”. When the MCU 23 finishes scanning the row, the MCU 23 sets “X” as “X1”, increments “Y”, and again scans the row, incrementing “X” one by one, until “X”=“X1”. The MCU 23 performs such process until “Y”=“Y1”, and scans the pixels of each row of the potential area “a0”.

In this scanning, the MCU 23 substitutes “1” for arrays “HcX[X][0]” and “VcY[Y][0]” corresponding to the XY-coordinate of the pixel exceeding the threshold value “Thl”. On the other hand, the MCU 23 substitutes “0” for arrays “HcX[X][0]” and “VcY[Y][0]” corresponding to the XY-coordinate of the pixel that is not more than the threshold value “Thl”. However, in the case that the MCU 23 has already substituted “1” for the array “HcX[X][0]”, the MCU 23 keeps such “1”. And in the case the MCU 23 has already substituted “1” for the array “VcY[Y][0]”, the MCU 23 keeps such “1”. FIG. 5 schematically shows the arrays “HcX[X][0]” and “VcY[Y][0]” that have stored “1” by hatching.

The leftmost element number “X” of the array “HcX[X][0]” which stores “1” are the X-coordinates “x0” and “x2”. The rightmost element number “X” of the array “HcX[X][0]” which stores “1” are the X-coordinates “x1” and “x3” The uppermost element number “Y” of the array “VcY[Y][0]” which stores “1” is the Y-coordinate “y1”. The lowermost element number “Y” of the array “VcY[Y][0]” which stores “1” is the Y-coordinate “y1”. In this way, the MCU 23 can determine the potential area “b0” and “b1”.

incidentally, the MCU23, also in the potential area “a1”, performs the process which is performed in the potential area “a0” of FIG. 5B.

Incidentally, it can be said that the orthographic projection to the horizontal axis (the X-axis) of the pixel value of the first potential area is stored in the array “HcX[X][0]”.

In addition, it can be said that the orthographic projection to the vertical axis of the pixel value of the first potential area (the Y-axis) is stored in the array “Vc[Y][0]”.

Next is the explanation of the process for detecting the state information of each operation article (the sword 3A-N, the mace 3B-N and the crossbow 3C-N). Incidentally, a player inputs the information of the operation article to use (the information about which operation articles he uses) into terminal 5-N in advance. Therefore, the information of the operation article to use is given to the camera unit 1 beforehand from the terminal 5-N.

[The Sword 3A-N]

At first, it will be explained how two retroreflection sheets 4B of the sword 3A-N appear in the differential image “DI”. In the present embodiment, it will be assumed that a player operates the sword 3A-N away from the camera unit 1 more than a certain distance. In this case, with the resolution of the image sensor 21 of the present embodiment, the distance between two retroreflection sheets 4B which appear in a differential image “DI” becomes smaller than one pixel.

Therefore, the images of two retroreflection sheets 4B appear in the differential image “DI” as one image. As a result, when a player uses the sword 3A-N as the operation article, the image of the retroreflection sheets 4 which appear in the differential image “DI” is always one (either the retroreflection sheets 4A or 4B).

Of course more high-resolution image sensor 21 can be used, too. In this case, for example, instead of the retroreflection sheet 4B of two semicylinder-shaped materials 37, one retroreflection sheet would be attached. Of course more low-resolution image sensor 21 can be used, too.

By the way, the MCU 23 performs judging processes in order of shield trigger requirements, special trigger requirements and swing trigger requirements. However, in the following, it will be explained in order of the shield trigger, the swing trigger and the special trigger, for convenience of the explanation.

[The Shield Trigger]

In the case that the area of the images of the retroreflection sheets which appear in the differential image “DI” exceeds a predetermined threshold value “Tha1”, the MCU 23 judges that the retroreflection sheet 4A which has large area is photographed. In the case where the MCU23 judges that the retroreflection sheet 4A was photographed in successional five differential images “DI”, the MCU 23 generates the shield trigger and performs the tilt detecting process.

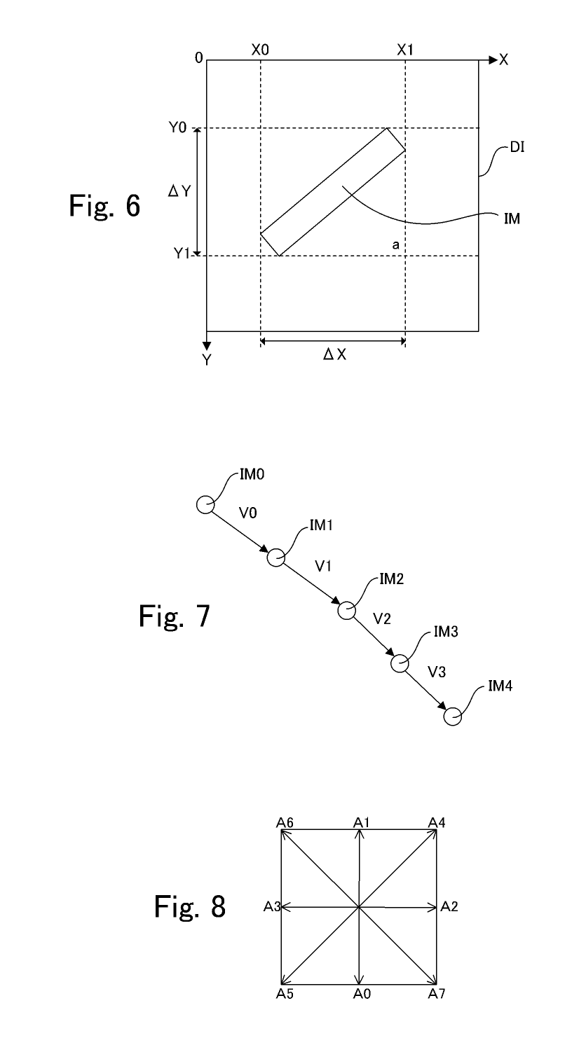

FIG. 6 is an explanatory view of a tilt detecting process of the sword 3A-N. As shown in FIG. 6, the MCU 23 calculates the ratio “r”=“ΔY/ΔX” which is a ratio between the vertical side length “ΔY” (=“Y1”−“Y0”) and horizontal side length “ΔX” (=“X1”−“X0”) of the current potential area “a” (circumscribed quadrangle of the image “IM” of the retroreflection sheet 4A) of the differential image “DI”. And the MCU 23, on the basis of the size of the ratio “r”, classifies the tilt of the sword 3A-N into any one of the horizontal direction “B0”, the slant direction “B1” or the perpendicularity direction “B2”.

[The Swing Trigger]

In the case that the area of the image of the retroreflection sheet is not more than the predetermined threshold value “Tha1”, the MCU 23 judges that the retroreflection sheet 4B was photographed. And the MCU 23 performs the swing detecting process.

FIG. 7 is an explanatory view of the swing detecting process of the sword 3A-N. As shown in FIG. 7, the MCU 23 judges whether the images “IM0” to “IM4” of the retroreflection sheet 4B was detected in succession in five differential images “DI”. If detected, the MCU 23 classifies the direction of each speed vectors “V0” to “V3” based on the XY-coordinate (Xr, Yr) of the five images “IM0” to “IM4” into any one of the eight directions “A0” to “A4” of FIG. 8. In this case, the directions which is in the range of clockwise direction 22.5 degrees and counterclockwise direction 22.5 degrees around the direction “A0” are classified into the direction “A0”. The similar explanation is applied to each direction “A1” to “A7”.

In the case that the directions of all speed vectors “V0” to “V3” are classified into the same direction, the MCU 23 compares the size of each speed vector “V0” to “V4” with the predetermined threshold value “Thv1”. And in the case the speed vectors “V0” to “V4” exceed the threshold value “Thv1”, the MCU 23 judges that a player swang the sword 3A-N, and the MCU 23 generates the swing trigger. In this case the MCU 23 assumes the same direction that speed vectors “V0” to “V3” were classified is a swing direction of the sword 3A-N.

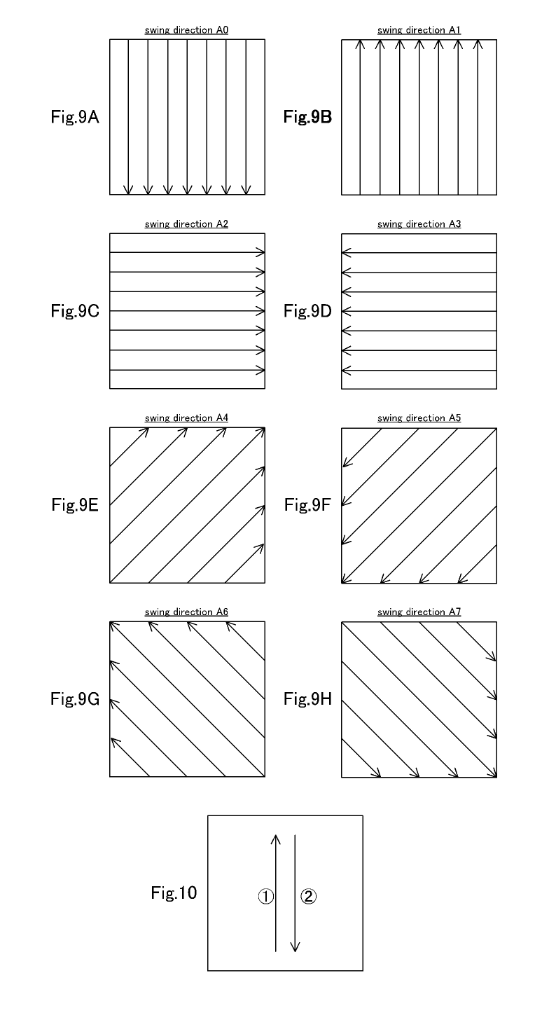

In addition, when the MCU 23 judges that a player swang the sword 3A-N, the MCU 23 calculates the direction of the sword 3A-N on the basis of the XY-coordinate (Xr, Yr) of the center image “IM2” among the five images “IM0” to “IM4”. In this case, as shown in FIG. 9A to FIG. 9H, the MCU23 classifies swing positions into any one of the seven positions for each of the swing directions “A0” to “A7”.

[The Special Trigger]

The MCU 23 determines whether the shield trigger was generated in this time and previous time. When the MCU 23 determines that the shield trigger was generated in both time, the MCU 23 detects the special operation of the sword 3A-N. When the MCU 23 detects the special operation, the MCU 23 generates the special trigger.

FIG. 10 is an explanatory view of the special operation of the sword 3A-N. As shown in FIG. 10, the MCU 23 determines whether the retroreflection sheet 4A moved vertically upwards, and then whether the retroreflection sheet 4A or 4B moved vertically downwards. That is to say, the MCU 23 determines whether there was the special operation. Specifically, as shown below.

When the MCU 23 determines the shield trigger was generated in previous time and this time, the MCU 23 turns on the first flag. And the MCU23 judges whether the images “IM0” to “IM4” of the retroreflection sheet 4A was detected in a series of five pieces of the differential images “DI” while the first flag was turned on and then turned off. In this case, the area of each image “IM0” to “IM4” must exceed the threshold value “Tha1” because they are the images of the retroreflection sheet 4A.

And when the MCU 23 judges that the images “IM0” to “IM4” of the retroreflection sheet 4A was detected in a series of five pieces of the differential images “DI”, the MCU 23 classifies the directions of each speed vector “V0” to “V3” that are based on the XY-coordinate (Xr, Yr) of the five images “IM0” to “IM4” into either of the eight directions “A0” to “A7” (refer to FIG. 8).

In the case where the directions of all speed vectors “V0” to “V3” are classified into the same direction, the MCU 23 compares the size of each speed vector “V0” to “V4” with the predetermined threshold value “Thv2”. And the MCU 23 turns on the second flag when all of the sizes of the speed vectors exceed the threshold value “Thv2”.

And, while the second flag was turned on and then turned off, the MCU23 judges whether the images “IM0” to “IM4” of the retroreflection sheet 4A was detected in a series of five pieces of the differential image “DI”. When the MCU 23 judges that the images “IM0” to “IM4” of the retroreflection sheet was detected in a series of five pieces, the MCU 23 classifies the directions of each speed vector “V0” to “V3” that are based on the XY-coordinate (Xr, Yr) of five images “IM0” to “IM4” into any one of the eight directions “A0” to “A7” (refer to FIG. 8).

In the case where all of the directions of speed vectors “V0” to “V3” are classified into the same direction, the MCU 23 compares the size of each speed vector “V0” to “V4” with the predetermined threshold value “Thv3”. And when each size of the speed vectors “V0” to “V3” exceeds the threshold value “Thv3”, the MCU 23 judges that a player performs the special operation, and the MCU 23 generates the special trigger. Incidentally, “Thv2”<“Thv3”.

Incidentally, The first flag is turned off after a elapse of the first predetermined time from the time when the first flag was turned on. In addition, the second flag is turned off after a elapse of the second predetermined time from the time when the second flag was turned on.

In the present embodiment, the MCU 23 transmits: the terminal 5-N: the trigger information (the shield trigger, the special trigger, the swing trigger, and a waiting state); the area and the XY-coordinate of the image of the retroreflection sheet 4; and the direction information and the position information of the swing (only in the case where the swing trigger was generated). Incidentally, the MCU 23 sets the waiting state as the trigger information when each requirement of the shield trigger, the special trigger or the swing trigger are not satisfied.

The terminal 5-N performs game processes depending on these information. In addition, these information are transmitted from the terminal 5-N to the host computer 31. The host computer 31 performs the game processes depending on these information and/or the host computer 31 transmits these information to other terminal 5-N. Such other terminal 5-N performs the game processes depending on these information.

[The Mace 3B-N]

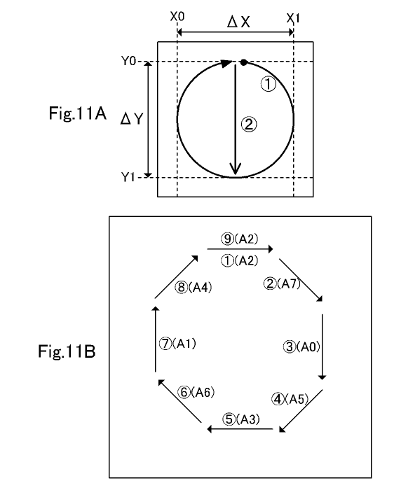

FIG. 11A and FIG. 11B are explanatory views of the special trigger based on the mace 3B-N. Referring to FIG. 11A, when the mace 3B-N is operated so that it draws a clockwise circle (In other embodiment, this condition can be changed to the counter clockwise circle) and then is swung down in a vertical direction, the MCU 23 generates the special trigger. Specifically, as follows.

Referring to FIG. 11B, if the images “IM0” to “IM2” of the retroreflection sheet 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A2”, the MCU 23 turns on the first flag.

In the case where the first flag is on, if the images “IM0” to “IM2” of the retroreflection sheet 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A7”, the MCU 23 turns on the second flag.

In the case where the second flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A0”, the MCU 23 turns on the third flag.

In the case where the third flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A5”, the MCU 23 turns on the fourth flag.

In the case where the fourth flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A3”, the MCU 23 turns on the fifth flag.

In the case where the fifth flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A6”, the MCU 23 turns on the sixth flag.

In the case where the sixth flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A1”, the MCU 23 turns on the seventh flag.

In the case where the seventh flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A4”, the MCU 23 turns on the eighth flag.

In the case where the eighth flag is on, if the images “IM0” to “IM2” of the retroreflection sheets 4C are detected in a series of three pieces of the differential image “DI”, moreover if the directions of two speed vectors “V0” and “V1” that are based on the XY-coordinate (Xr, Yr) of the three images “IM0” to “IM2” are all classified into the direction “A2”, the MCU 23 turns on the ninth flag.

However, the MCU 23 turns off all the first to the eighth flags if the ninth flag is not turned on within the third predetermined time from the time the first flag was turned on.

In the case where the ninth flag is on, the MCU 23 judges whether the size of the circle drawn by the mace 3B-N is bigger than a predetermined value. If bigger, the MCU 23 turns on the tenth flag, otherwise the MCU 23 turns off all the first to the ninth flags. Specifically, as follows.

Referring to FIG. 11A, the MCU 23 calculates: a difference “ΔX” between the largest coordinate “X1” and the smallest coordinate “X0” of the X-coordinate “Xr” of the image of the retroreflection sheet 4C; and a difference “ΔY” between the largest coordinate “Y1” and the smallest coordinate “Y0” of the Y-coordinate “Yr” of the image of the retroreflection sheet 4C. And the MCU 23 calculates a sum “s”=“ΔX”+“ΔY”. If the sum “s” is bigger than a predetermined value, the MCU 23 turns on the tenth flag.

In the case where the tenth flag is on, if the images “IM0” to “IM2” of the retroreflection sheet 4C are detected in a series of three pieces of the differential image “DI”, the MCU 23 classifies the directions of two speed vectors “V0” and “V1” that are based on the XY-coordinate (Xr, Yr) of the three images “IM0” to “IM2” into any one of the eight directions “A0” to “A7”. In the case where all the directions of the two speed vectors “V0” and “V1” are classified into the direction “A0”, the MCU23 judges whether the sizes of the two speed vectors “V0” and “V1” exceed the threshold value “Thv4”.

And when each size of the speed vector “V0” and “V1” exceeds the threshold value “Thv4”, the MCU 23 judges that a player performed the special operation, and the MCU 23 generates the special trigger. Incidentally, the MCU 23 turns off all the first to the tenth flags if the special trigger is not generated within the fourth predetermined time from the time the tenth flag was turned on.

In the present embodiment, the MCU 23 transmits to the terminal 5-N: the trigger information (the special trigger, the waiting state); and the area and the XY-coordinate of the image of the retroreflection sheet 4. Incidentally, if the requirements of the special trigger was not satisfied, the MCU 23 sets the waiting state as the trigger information.

The terminal 5-N performs the game processes depending on these information. In addition, these information is transmitted from the terminal 5-N to the host computer 31. The host computer 31 performs the game processes depending on these information and/or the host computer 31 transmits these information to other terminal 5-N. Such other terminal 5-N performs the game processes depending on these information.

[The Crossbow 3C-N]

At first the MCU 23 detects the number of the retroreflection sheets 4 which appear in the differential image “DI”, and performs the process according to the number. The detecting method for the number of the retroreflection sheets 4 is described above (refer to FIG. 4 and FIG. 5).

In the case where the number of the retroreflection sheets 4 is one, the MCU 23 judges whether the requirement of the charge trigger are satisfied or not. In addition, In the case where the number of the retroreflection sheets 4 is two, the MCU 23 judges whether the requirement of the shield trigger is satisfied or not, and if not, the MCU 23 judges whether the requirement of the switch trigger is satisfied or not. Furthermore, in the case where the number of the retroreflection sheet 4 is three, the MCU 23 judges whether the requirement of the shooting trigger is satisfied or not.

Incidentally, in the case where the two or more requirements of the four triggers are redundantly satisfied, the priority is in order of the charge trigger, the shield trigger, the switch trigger and the shooting trigger. In what follows, the explanation will be done in order of the charge trigger, the shield trigger, the switch trigger and the shooting trigger.

[The Charge Trigger]

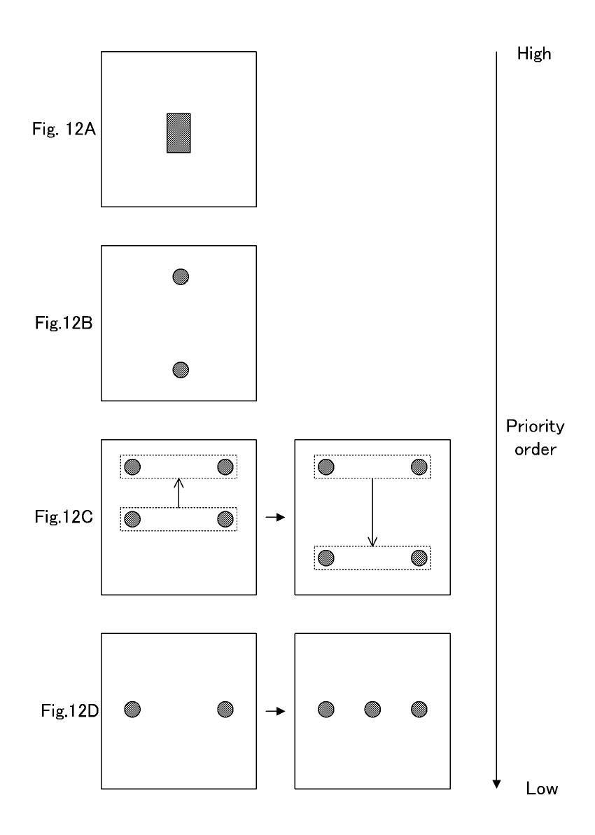

FIG. 12A is an explanatory view of the charge trigger based on the crossbow 3C-N. With reference to FIG. 12A, in the case where the only one image of the retroreflection sheet 4 appears in the differential image “DI”, the MCU 23 judges whether the area of such image is bigger than the threshold value “Tha2” or not. If bigger, the MCU 23 judges that the retroreflection sheet 4G was photographed, and generates the charge trigger.

[The Shield Trigger]

FIG. 12B is an explanatory view of the shield trigger based on the crossbow 3C-N. Referring to FIG. 12B, in the case where the number of the retroreflection sheets 4 which appears in the differential image “DI” is two, the MCU 23 judges that the retroreflection sheets 4E and 4F were photographed, and the MCU 23 calculates a tilt of the line connecting their XY-coordinates (Xr, Yr).

When the tilt is bigger than a predetermined value, the MCU 23 generates the shield trigger. In addition, in the case where the two retroreflection sheets 4 appear in the differential image “DI”, the MCU 23 calculates a coordinate of a middle point of their XY coordinates (Xr, Yr).

[The Switch Trigger]

In the case where the two retroreflection sheets 4 appear in the differential image “DI” and the requirement of the shield trigger is not satisfied, the MCU 23 judges, like the detection of the swing trigger of the sword 3A-N, whether the requirement of the switch trigger is satisfied or not. However, in the judgment, the MCU 23 does not use the XY-coordinate (Xr, Yr) of each retroreflection sheet 4E and 4F, but uses the coordinates of those middle point. Specifically, as follows.

FIG. 12C is an explanatory view of the switch trigger based on the crossbow 3C-N. Referring to FIG. 12C, in the case where the images of the retroreflection sheets 4E and 4F are detected in a series of five pieces of the differential image “DI”, the MCU 23 judges whether all the directions of the four speed vectors based on the five coordinates of the middle points corresponding to the images were classified into the direction “A1” or not. If all of the directions are classified into the direction “A1”, the MCU 23 judges whether all of the sizes of the four speed vectors exceed the threshold value “Thv5”. If all of the sizes of the four speed vectors exceeds the threshold value “Thv5”, the MCU 23 turns on the predetermined flag.

While the MCU 23 turns on the predetermined flag and then turns off it, if the MCU 23 detects the images of the retroreflection sheets 4E and 4F in a series of five pieces of the differential image “DI”, the MCU 23 judges whether all the directions of the four speed vectors based on the five coordinates of the middle points corresponding to the images were classified into the direction “A0” or not. If all of the directions are classified into the direction “A0”, the MCU 23 judges whether all of the sizes of the four speed vectors exceed the threshold value “Thv6”. If all of the sizes of four speed vectors exceed the threshold value “Thv6”, the MCU 23 turns on the switch trigger.

Incidentally, the MCU 23 turns off the predetermined flag if the switch trigger is not generated within a fifth predetermined time from the time when the predetermined flag was turned on.

[The Shooting Trigger]

FIG. 12D is an explanatory view of the shooting trigger based on the crossbow 3C-N. Referring to FIG. 12D, in the case where the three retroreflection sheets 4 appear in the differential image “DI”, the MCU 23 judges that they are the retroreflection sheets 4D, 4E and 4F. And the MCU 23 judges whether the retroreflection sheets which appeared in the previous differential image are only the retroreflection sheets 4E and 4F or not, and if only the retroreflection sheets 4E and 4F appear, the MCU 23 generates the shooting trigger. However, the MCU 23 does not generate the shooting trigger in the case where the three retroreflection sheets 4D, 4E and 4F appeared in the previous differential image. In other words, the MCU 23 generates the shooting trigger when the number of the retroreflection sheets 4 appearing in the differential image “DI” changes to three from two.

However, in the case where the three retroreflection sheets 4 appear in the differential image “DI”, before the judgment of the requirement of the shooting trigger, the MCU 23 calculates differences |ar0−ar1|, |ar1−ar2| and |ar2−ar0|. “ar0”, and “ar2” are the area of three retroreflection sheets 4. And the MCU 23 calculates the difference of: an average of the areas of the two retroreflection sheets 4 whose difference of the area is smallest; and the largest area of the retroreflection sheet 4. If such difference is bigger than a predetermined value, the MCU 23 judges the retroreflection sheet 4 which has the biggest area is the retroreflection sheet 4G, and generates the charge trigger.

In addition, in the case where the three retroreflection sheets 4 appear in the differential image “DI” and the requirement of the charge trigger is not satisfied, before the judgment of the requirement of the shooting trigger, the MCU 23 judges whether the retroreflection sheets 4E and 4F which exist at both ends satisfy the requirement of the shield trigger or not, and if they satisfy, the MCU 23 generates the shield trigger.

Therefore, in the case where the three retroreflection sheets 4 appear in the differential image “DI” and the requirements of the charge trigger and the shield trigger are not satisfied, the MCU 23 judges the requirement of the shooting trigger.

In the present embodiment, the MCU 23 transmits to the terminal 5-N: the trigger information (the charge trigger, the shield trigger, the switch trigger, the shooting trigger and the waiting state); and the area and the XY-coordinate of the image of the retroreflection sheets 4. In addition, if two retroreflection sheets 4 appear in the differential image “DI”, the MCU 23 transmits the coordinate of their middle point to the terminal 5-N. Furthermore, if three retroreflection sheets 4 appear in the differential image “DI”, the MCU 23 transmits to the terminal 5-N the coordinate of the middle point of two retroreflection sheets 4 which are at those both ends. However, even if three retroreflection sheets appear in the differential image “DI”, when the MCU 23 judges that one of those retroreflection sheets 4 is the retroreflection sheet 4G, the MCU 23 transmits the XY-coordinate (Xr, Yr) of the retroreflection sheet 4G. Incidentally, the MCU 23 sets the waiting state as the trigger information when each requirement of the shield trigger, the special trigger or the swing trigger is not satisfied.

The terminal 5-N performs the game processes depending on these information. In addition, these information is transmitted from the terminal 5-N to the host computer 31. The host computer 31 performs the game processes depending on these information and/or the host computer 31 transmits these information to other terminals 5-N. Such other terminal 5-N performs the game processes depending on these information.

As described above, in the case of the crossbow 3C-N, the crossbow 3C-N has the retroreflection sheets 4E and 4F which always keep the exposure state, so it is always possible to detect the input and the input type by the crossbow 3C-N on the basis of the photographed image of the retroreflection sheets 4E and 4F. In addition, the crossbow 3C-N has the retroreflection sheet 4D which can change the exposure state and the non-exposure state, so it is possible to give different inputs according to whether the retroreflection sheet 4D is photographed or not; therefore, the input by the retroreflection sheets becomes diverse.

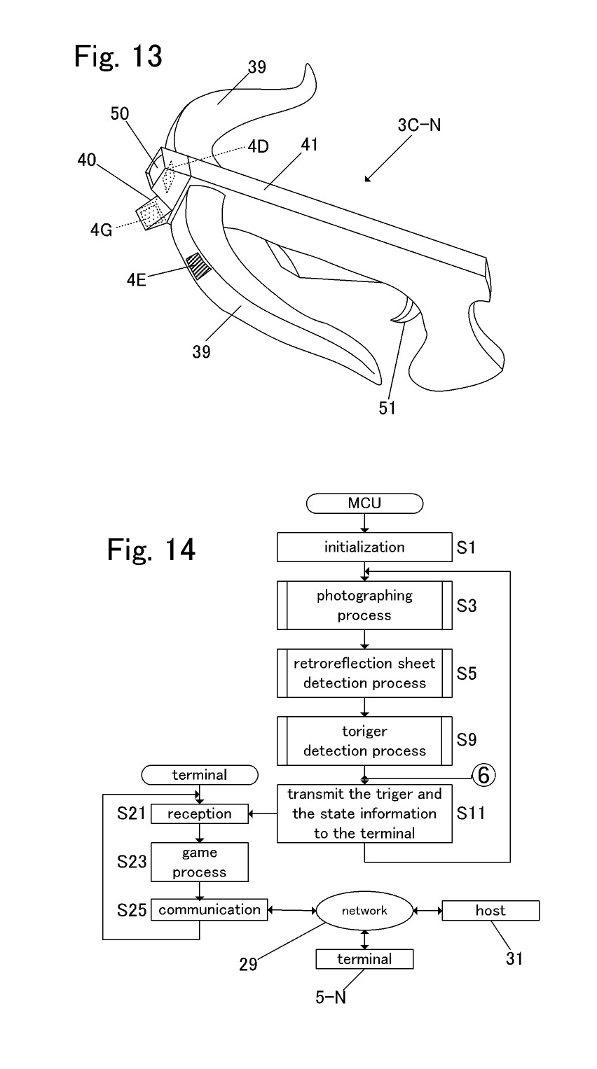

By the way, FIG. 13 is another example of the operation article 3C-N of FIG. 3C. Referring to FIG. 13, in the crossbow 3C-N of another example, the mounting locations of the shutter 50 and the retroreflection sheet 4G are different from the crossbow 3C-N of FIG. 3C.

The shutter 50 is freely openably/closably attached to the tip of the pedestal 41. And, the retroreflection sheet 4D is attached to on the tip of pedestal 41 and the back side of shutter 50. While the trigger 51 is not pulled, the shutter 50 keeps closed. Therefore, in this case, the retroreflection sheet 4D is hidden by the shutter 50 and is not exposed. On the other hand, while the trigger 51 is pulled, the shutter 50 keeps open. Therefore, in this case, the retroreflection sheet 4D is exposed.

In addition, on the tip of pedestal 41, a component 40 is attached to so that it becomes the obtuse angle (in relation to the trigger 51) for long distance direction of the pedestal 41. On the back of this component 40, that is, on an aspect facing the trigger 51, the retroreflection sheet 4G is attached. Therefore, retroreflection sheet 4G is photographed while the pedestal 41 turns to the camera unit 1, and the retroreflection sheet 4G is not photographed while the tip of the pedestal 41 turns upward.

Because the retroreflection sheet 4G is attached to so that it becomes an obtuse angle for long distance direction of the pedestal 41, the retroreflection sheet 4G is not photographed unless the tip of the pedestal 41 is turned more upward compared to the crossbow 3C-N of FIG. 3C whose the retroreflection sheet 4G is attached to so that it becomes an acute angle for long distance direction of the pedestal 41. Therefore, the photographing of the retroreflection sheet 4G which a player does not intend can be avoided.

FIG. 14 is a flowchart showing the overall process flow of the MCU23 of FIG. 2. Referring to FIG. 14, the MCU 23 performs an initialization processes, for example the initialization of variables, in step S1. In step S3, the MCU 23 controls the image sensor 37 to carry out the photographing process of the retroreflection sheets 4. In step S5, MCU23 performs a process for detecting the retroreflection sheet 4 on the basis of the differential image signal from the image sensor 21, and calculates the state information of the retroreflection sheets 4. In step S9, the MCU 23 performs detecting process of the trigger based on a detection result of step S5. In step S11, the MCU23 transmits a trigger (in other words a trigger flag to be described below) and the state information to the terminal 5-N.

Then, in step S21, the terminal 5-N receives the trigger and the state information. In step S23, the terminal 5-N performs a game process depending on the trigger and the state information received. In addition, in step S25, the terminal 5-N transmits the trigger and the state information to the host computer 31 via the network 29. The host computer 31 performs a game process depending on the trigger and the state information, and/or transmits the trigger and the state information to other terminal 5-N. Such other terminals 5-N execute a game process depending on these information. The plural terminals 5-N carry out such process, and carry out the online game. Of course the terminals 5-N can transmit the trigger and the state information directly to other terminal(s) 5-N via the network and execute the online game.

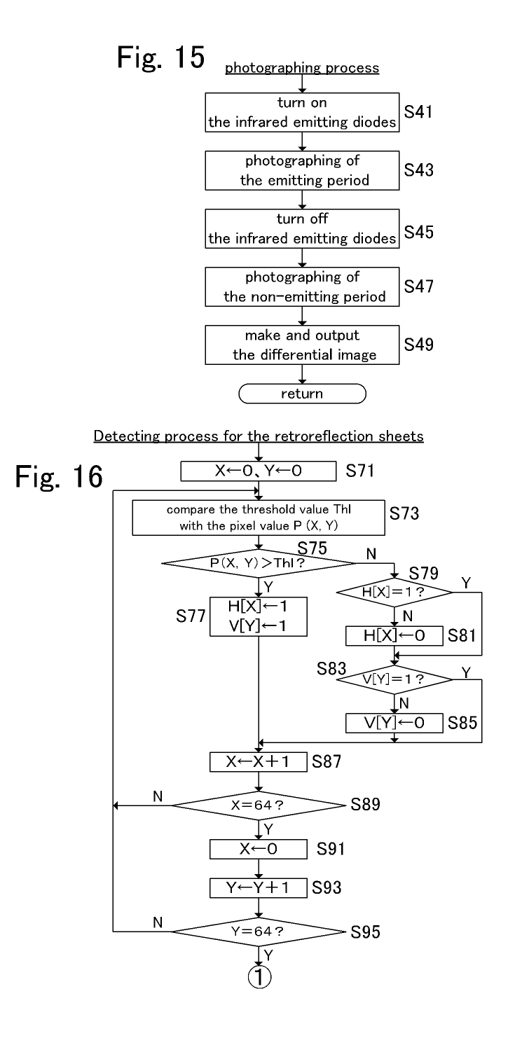

FIG. 15 is a flowchart showing a flow of the photographing process of step S3 of FIG. 14.

Referring to FIG. 15, in step S41, the MCU23 makes the image sensor 21 turn on the infrared emitting diodes 11. In step S43, the MCU 23 makes the image sensor 21 carry out the photographing with the infrared light illumination. In step S45, the MCU23 makes the image sensor 21 turn off the infrared emitting diodes 11. In step S47, the MCU 23 makes the image sensor 21 carry out the photographing without the infrared light illumination. In step S49, the MCU 23 makes the image sensor 21 make and output the differential image between the image of the emitting period and the image of the non-emitting period. In this way, the image sensor 21 performs the photographing of the emitting period and the photographing of the non-emitting period, in response to the control of the MCU 23. In addition, by the above-mentioned control, the infrared emitting diodes 11 functions as a stroboscope.

FIG. 16 to FIG. 22 are flowcharts showing the detecting processes for the retroreflection sheets of step S5 of FIG. 14. Referring to FIG. 16, the MCU 23 substitutes “0” for variables “X” and “Y” in step S71. In step S73, the MCU 23 compares the threshold value “Thl” with the pixel value P (X, Y) of the differential image. For example, the pixel value is a brightness value. In step S75, the MCU 23 proceeds to step S77 if the pixel value P (X, Y) exceeds the threshold value “Thl”, otherwise the MCU 23 proceeds to step S79.

In step S77, the MCU 23 substitutes “1” for variables “H[X]” and “V[Y]” respectively. On the other hand, in step S79, the MCU23 proceeds to step S83 if the variable “H[X]” is “1”, otherwise the MCU 23 proceeds to step S81. In step S81, the MCU 23 substitutes “0” for the variable “H[X]”.

In step S83, the MCU23 proceeds to step S87 if the variable “V[Y]” is “1”, otherwise the MCU 23 proceeds to step S85. In step S85, the MCU 23 substitutes “0” for variable “V[Y]”.

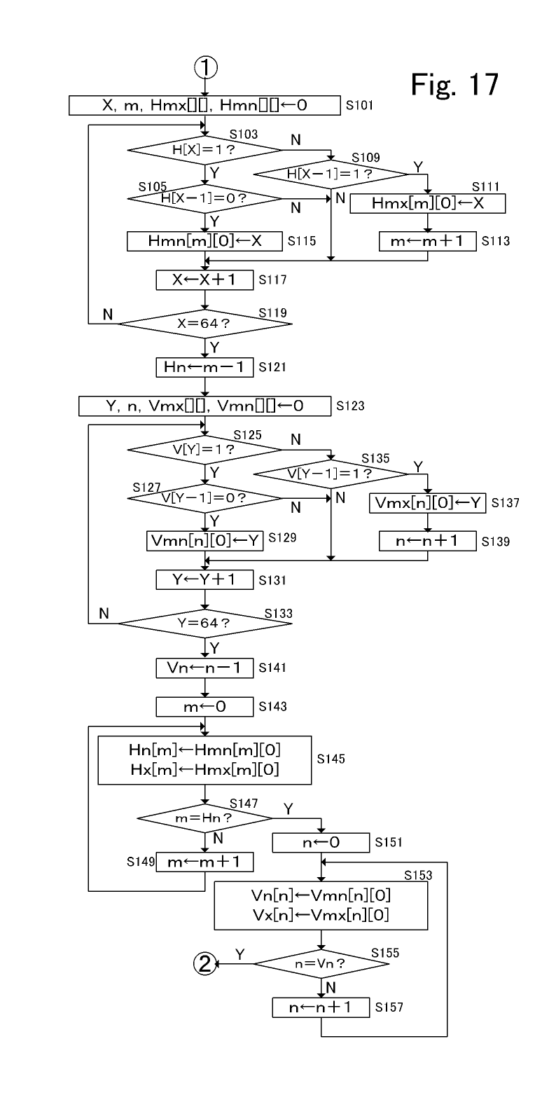

In step S87, the MCU 23 increments a value of a variable “X” by one. In step S89, the MCU 23 proceeds to step S91 if the value of the variable “X” is “64”, otherwise the MCU 23 returns to step S73. In step S91, the MCU 23 substitutes “0” for the variable X. In step S93, the MCU 23 increments a value of a variable “Y” by one. In step S95, the MCU 23 proceeds to step S101 of the FIG. 17 if the value of the variable “Y” is “64”, otherwise the MCU 23 returns to step S73.

In this way, the differential image is scanned, and the values are set in the arrays “H[X]” and “V[Y]” prescribing the first potential area (refer to FIG. 4 and FIG. 5A). For example, the first potential area is the areas “a0” to “a3” in the case of FIG. 4, and the areas “a0” and “a1” in the case of FIG. 5A.

Referring to FIG. 17, in step S101, the MCU 23 substitutes “0” for the variables “X”, “m”, “Hmx[ ][ ]” and “Hmn[ ][ ]” respectively. In step S103, the MCU 23 proceeds to step S105 if a value of the variable “H[X]” is “1”, otherwise the MCU 23 proceeds to step S109. In step S105, the MCU 23 proceeds to step S115 if a value of the variable “H[X−1]” is “0”, otherwise the MCU 23 proceeds to step S117. In step S115, the MCU 23 substitutes the value of the variable “X” for the variable “Hmn[m][0]”.

In step S109, the MCU 23 proceeds to step S111 if a value of the variable “H[X−1]” is “1”, otherwise the MCU 23 proceeds to step S117. In step S111, the MCU 23 substitutes the value of the variable “X” for the variable “Hmx[m][0]”. In step S113, the MCU 23 increments the value of the variable “m” by one.

In step S117, the MCU 23 increments the value of the variable “X” by one. In step S119, the MCU 23 proceeds to step S121 if the value of the variable “X” is “64”, otherwise the MCU 23 returns to step S103. In step S123, the MCU 23 substitutes the value that subtracted “1” from the value of the variable “m” for the variable “Hn”.

Above-mentioned processes in step S101 to S121 are the processes for calculating the leftmost element number “X” (X-coordinate) of the array “H[X]” which stores “1” and the rightmost element number “X” (X-coordinate) of the array “H[X]” which stores “1”.

In step S123, the MCU 23 substitutes “0” for the variables “Y”, “n”, “Vmx[ ][ ]” and “Vmn[ ][ ]” respectively. In step S125, the MCU23 proceeds to step S127 if the value of the variable “V[Y]” is “1”, otherwise the MCU 23 proceeds to step S135. In step S127, the MCU23 proceeds to step S129 if the value of the variable “V[Y−1]” is “0”, otherwise the MCU 23 proceeds to step S131. In step S129, the MCU 23 substitutes the value of the variable “Y” for the variable “Vmn[m][0]”.

In step S135, the MCU23 proceeds to step S137 if the value of the variable “V[Y−1]” is “1”, otherwise the MCU 23 proceeds to step S131. In step S137, the MCU 23 substitutes the value of the variable “Y” for the variable “Vmx[m][0]”. In step S139, the MCU 23 increments the value of the variable “n” by one.

In step S131, the MCU 23 increments the value of the variable “Y” by one. In step S133, the MCU 23 proceeds to step S141 if the value of the variable “Y” is “64”, otherwise the MCU 23 returns to step S125. In step S141, the MCU 23 substitutes the value that subtracted “1” from the value of the variable “n” for the variable “Vn”.

Above-mentioned processes in step S123 to S141 are the processes for calculating the uppermost element number “Y” (Y-coordinate) of the array “V[Y]” which stores “1” and the lowermost element number “Y” (Y-coordinate) of the array “V[Y]” which stores “1”.

In this way, the differential image is scanned, and the first potential area is determined (refer to FIG. 4 and FIG. 5A).

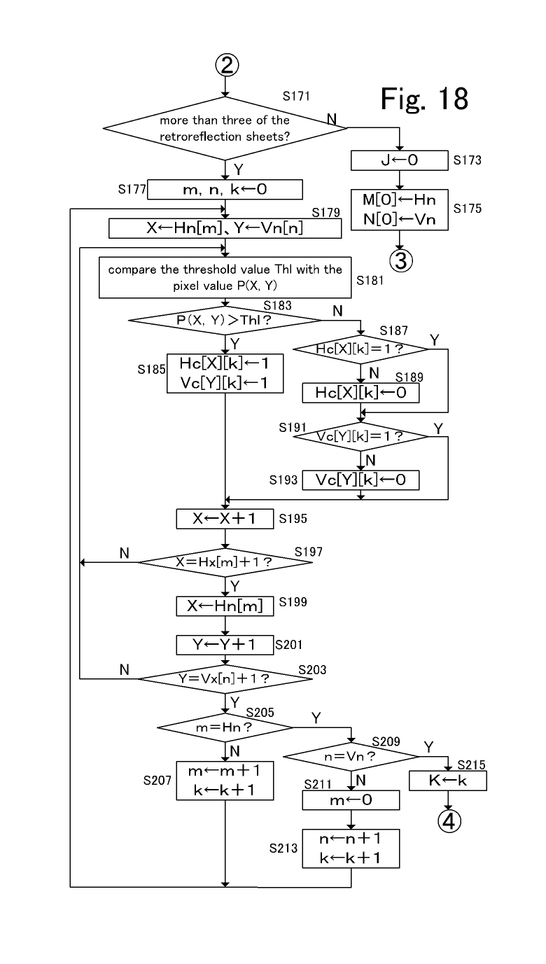

In step S143, the MCU 23 substitutes “0” for the variable “m”. In step S145, the MCU 23 substitutes the value of the variable “Hmn[m][0]” for the variable “Hm[m]” and substitutes the value of the variable “Hmx[m][0]” for the variable “Hx[m]”. In step S147, the MCU 23 proceeds to S151 if the value of the variable “m” is the value of the variable “Hn”, otherwise the MCU 23 proceeds to S149. In step S149, the MCU 23 increments the value of the variable “m” by one and then returns to step S145. In step S151, the MCU 23 substitutes “0” for the variable “n”. In step S153, the MCU 23 substitutes the value of the variable “Vmn[n][0]” for the variable “Vn[m]” and substitutes the value of the variable “Vmx[n][0]” for the variable “Vx[n]”. In step S155, the MCU 23 proceeds to step S71 of FIG. 18 if the value of the variable “n” is “Vn”, otherwise the MCU 23 proceeds to step S157. In step S157, the MCU 23 increments the value of the variable “n” by one.

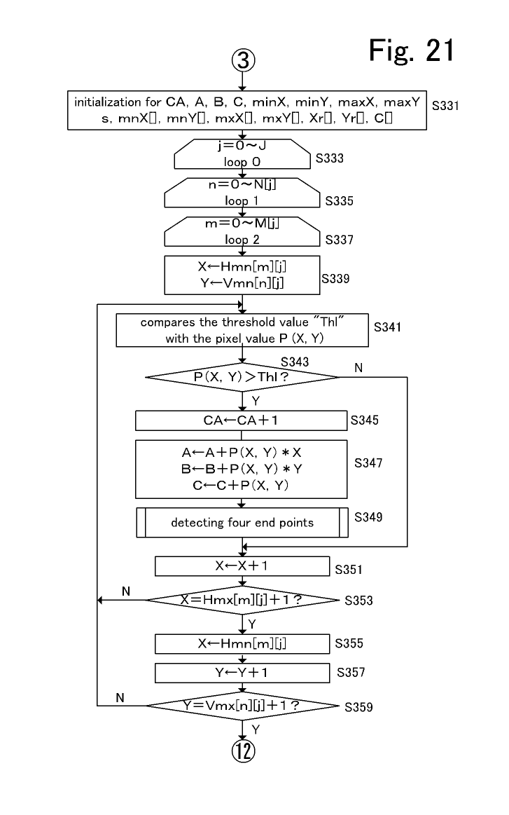

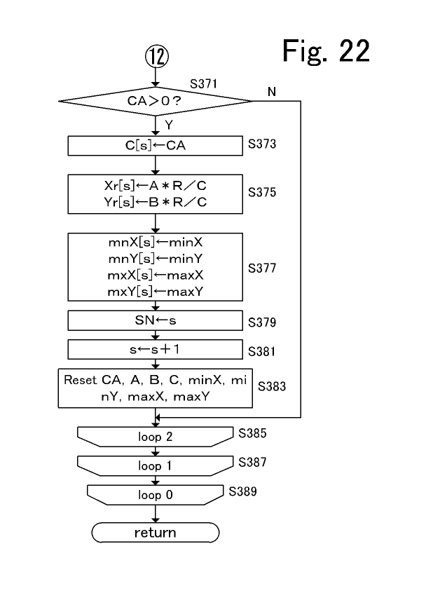

Referring to FIG. 18, in step S171, if there is a possibility that more than three of the retroreflection sheets 4 appear in the differential image, that is, if the crossbow 3C-N is used as the operation article, the MCU 23 proceeds to step S177; otherwise the MCU 23 proceeds to step S173. In step S173, the MCU 23 substitutes “0” for the variable “J”. In step S175, the MCU 23 substitutes the value of the variable “Hn” for the variable “M[0]”, substitutes the value of the variable “Vn” for the variable “N[0]”, and then proceeds to step S331 of FIG. 21.

Referring to FIG. 21, the MCU 23 initializes the variables “CA”, “A”, “B”, “C”, “minX”, “minY”, “maxX”, “maxY”, “s”, “mnX[ ]”, “mnY[ ]”, “mxX[ ]”, “mxY[ ]”, “Xr[ ]”, “Yr[ ]”, and “C[ ]” in step S331. And the MCU 23 repeats step S333 to step S389 of FIG. 22, while updating the variable “j”. And the MCU 23 repeats step S335 to step S387, while updating the variable “n”. Furthermore, the MCU 23 repeats step S337 to step S385 of FIG. 22, while updating the variable “m”.

In step S339, the MCU 23 substitutes the value of the variable “Hmn[m][j]” for the variable “X” and substitutes the value of the variable “Vmn[n][j]” for the variable “Y”. In step S341, the MCU 23 compares the threshold value “Thl” with the pixel value P (X, Y) of the differential image. In step S343, the MCU 23 proceeds to step S345 if the pixel value P (X, Y) exceeds the threshold value “Thl”, otherwise the MCU 23 proceeds to step S351.

In step S345, the MCU 23 increments by one the value of the counter “CA” which calculates the area of the image of the retroreflection sheet. In step S347, the MCU 23 updates the value of variable “A”, “B” and “C” by the next formula.

A←A+P(X,Y)*X

B←B+P(X,Y)*X

C←C+P(X,Y)

In step S349, the MCU 23 detects the four end points (the largest X-coordinate, the largest Y-coordinate, the smallest X-coordinate, the smallest Y-coordinate) of the image of the retroreflection sheets 4. In step S351, the MCU 23 increments the value of the variable “X” by one. In step S353, if the value of the variable “X” is equal to the value that added “1” to the value of the variable “Hmx[m][j]”, the MCU 23 proceeds to step S355, otherwise the MCU 23 returns to step S341. In step S355, the MCU 23 substitutes the value of the variable “Hmn[m][j]” for the variable “X”.

In step S357, the MCU 23 increments the value of the variable “Y” by one. In step S359, if the value of the variable “Y” is equal to the value that added “1” to the value of the variable “Vmx[n][j]”, the MCU 23 proceeds to step S371 of FIG. 22, otherwise the MCU 23 returns to step S341.

By the processes of step S339 to S359, the four end points and the area of the images of the retroreflection sheets are calculated.

Referring to FIG. 22, in step S371, if the value of the counter “CA” exceeds “0”, the MCU 23 proceeds to step S373, otherwise the MCU 23 proceeds to step S385. If the value of the counter “CA” exceeds “0”, it means that there is the image of the retroreflection sheet in the potential area, therefore, to calculate and store the coordinate (Xr, Yr) of the image, the MCU 23 proceeds to step S373. In step S373, the MCU 23 substitutes the value of the counter “CA” for the variable “C[s]”. In step S375, the MCU 23 substitutes a value of “A*R/C” for the variable “Xr[s]” and substitutes a value of “B*R/C” for the variable“Yr[s]”. In step S377, the MCU 23 substitutes a value of the variable “minX” for the variable “mnX[s]” and substitutes a value of the variable “minY” for the variable “mnY[s]” and substitutes a value of the variable “maxX” for the variable “mxX[s]” and substitutes a value of “maxY” for the variable “mxY[s]”.

In step S379, the MCU 23 substitutes a value of the counter “s” which counts the number of the photographed retroreflection sheets for the variable “SN”. In step S381, the MCU 23 increments the value of the counter “s” by one. In step S383, the MCU 23 resets the variables “CA”, “A”, “B”, “C”, “minX”, “minY”, “maxX” and “maxY”, and then the MCU 23 proceeds to step S385.

Returning to FIG. 21, next is an explanation of the details of step S349.

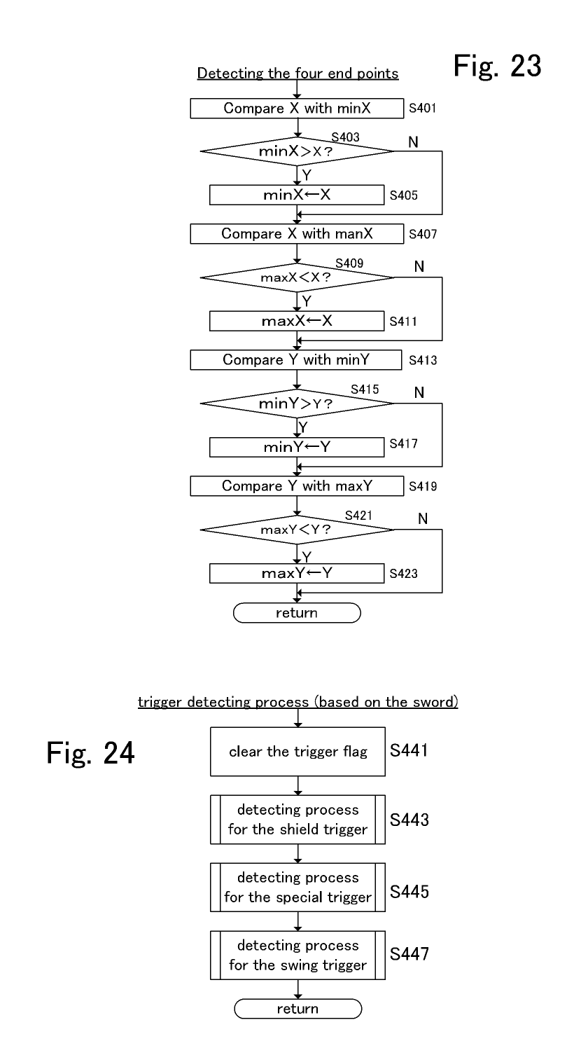

FIG. 23 is a flowchart showing the four end points detecting process in step S349 of FIG. 21. Referring to FIG. 23, in step S401, the MCU 23 compares the value of the variable “X” with the value of the variable “minX”. In step S403, if the value of the variable “minX” is larger than the value of the variable “X”, the MCU 23 proceeds to step S405, otherwise the MCU 23 proceeds to step S407. In step S405, the MCU 23 substitutes the value of the variable “X” for the variable “minX”.

In step S407, the MCU 23 compares the value of the variable “X” with the value of the variable “maxX”. In step S409, if the value of the variable “minX” is smaller than the value of the variable “X”, the MCU 23 proceeds to step S411, otherwise the MCU 23 proceeds to step S413. In step S411, the MCU 23 substitutes the value of the variable “X” for the variable “maxX”.

In step S413, the MCU 23 compares the value of the variable “Y” with the value of variable “minY”. In step S415, if the value of the variable “minY” is larger than the value of the variable “Y”, the MCU 23 proceeds to step S417, otherwise the MCU 23 proceeds to step S419. In step S417, the MCU 23 substitutes the value of the variable “Y” for the variable “minY”.

In step S419, the MCU 23 compares the value of the variable “Y” with the value of variable “maxY”. In step S421, if the value of the variable “maxY” is smaller than the value of the variable “Y”, the MCU 23 proceeds to step S423, otherwise the MCU 23 returns.

Returning to FIG. 18, in step S177, the MCU 23 substitutes “0” for the variables “m”, “n” and “k” respectively. In step S179, the MCU 23 substitutes the value of the variable “Hn[m]” for the variable “X” and substitutes the value of the variable “Vn[n]” for the variable Y. In step S181, the MCU 23 compares the threshold value “Thl” with the pixel value P(X, Y) of the differential image.

In step S183, the MCU 23 proceeds to step S185 if the pixel value P (X, Y) exceeds the threshold value “Thl”, otherwise the MCU 23 proceeds to step S187.

In step S185, the MCU 23 substitutes “1” for the variables “Hc[X][k”] and “Vc[Y][k]” respectively. On the other hand, in step S187, the MCU23 proceeds to step S191 if the value of the variable “Hc[X][k]” is “1”, otherwise the MCU 23 proceeds to step S189. In step S189, the MCU 23 substitutes “0” for the variable “Hc[X][k]”. In step S191, the MCU23 proceeds to step S195 if the value of the variable “V[Y] [k]” is “1”, otherwise the MCU 23 proceeds to step S193. In step S193, the MCU 23 substitutes “0” for the variable “Vc[Y][k]”.

In step S195, the MCU 23 increments the value of the variable “X” by one. In step S197, if the value of the variable “X” is equal to the value that added “1” to the value of the variable “Hx[m]”, the MCU 23 proceeds to step S199, otherwise the MCU 23 returns to step S181. In step S199, the MCU 23 substitutes the value of variable “Hn[m]” for the variable X. In step S201, the MCU 23 increments the value of the variable “Y” by one. In step S203, if the value of the variable “Y” is equal to the value that added “1” to the value of the variable “Vx[n]”, the MCU 23 proceeds to step S205, otherwise the MCU 23 returns to step S181.

In step S205, if the value of the variable “m” is equal to the value of the variable “Hn”, the MCU 23 proceeds to step S209, otherwise the MCU 23 proceeds to step S207. In step S207, the MCU 23 increments one each value of the variable “m” and “k”, and then returns to step S179. In step S209, if the value of the variable “n” is equal to the value of the variable “Vn”, the MCU 23 proceeds to step S215 of FIG. 18, otherwise the MCU 23 proceeds to step S211. In step S211, the MCU 23 substitutes “0” for the variable “m”. In step S213, the MCU 23 increments one each value of the variable “n” and “k”, and then returns to step S179.

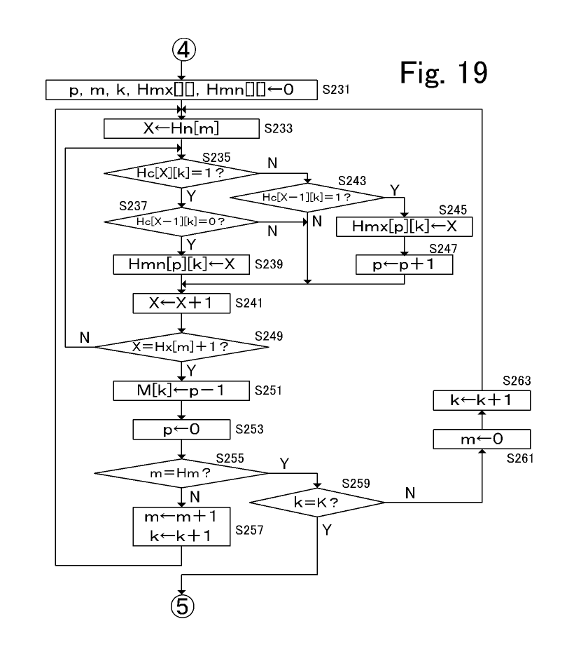

In step S215, the MCU 23 substitutes a value of variable “k” for the variable “K” and proceeds to step S231 of FIG. 19.

In this way, each first potential area is scanned, and the arrays “Hc[X][k]” and “Vc[Y][k]” prescribing the second potential area are set the value (refer to FIG. 5B). For example, the second potential area is the area “b0” and “b1” in FIG. 5B.

Referring to FIG. 19, in step S231, the MCU 23 substitutes “0” for the variables “p”, “m”, “k”, “Hmx[ ][ ]” and “Hmn[ ][ ]” respectively. In step S233, the MCU 23 substitutes the value of variable “Hn[m”] for the variable “X”. In step S235, the MCU 23 proceeds to step S237 if the variable “Hc[X][k]” is “1”, otherwise the MCU 23 proceeds to step S243. In step S237, the MCU 23 proceeds to step S239 if the variable “Hc[X−1][k]” is “0”, otherwise the MCU 23 proceeds to step S241. In step S239, the MCU 23 substitutes the value of the variable “X” for the variable “Hmn[p][k]”.

In step S243, the MCU 23 proceeds to step S245 if the variable “Hc[X−1][k]” is “0”, otherwise the MCU 23 proceeds to step S241. In step S245, the MCU 23 substitutes the value of the variable “X” for the variable “Hmx[p][k]”. In step S247, the MCU 23 increments the value of the variable “p” by one.

In step S241, the MCU 23 increments the value of the variable “X” by one. In step S249, if the value of the variable “X” is equal to the value that added “1” to the value of the variable Hx[m], the MCU 23 proceeds to step S251, otherwise the MCU 23 returns to step S235. In step S251, the MCU 23 substitutes the value that subtracted “1” from the value of the variable “p” for the variable “M[k]”.

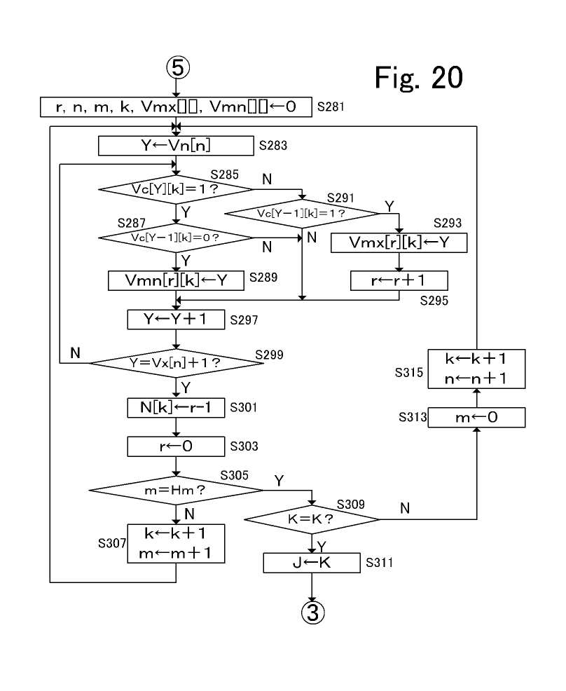

In step S253, the MCU 23 substitutes “0” for the variable “p”. In step S255, if the value of the variable “m” is equal to the value of the variable “Hm”, the MCU 23 proceeds to step S259, otherwise the MCU 23 proceeds to step S257. In step S257, the MCU 23 increments one each value of the variable “m” and “k”, and then returns to step S233. On the other hand, In step S259, if the value of the variable “k” is equal to the value of the variable “K”, the MCU 23 proceeds to step S259 of FIG. 20, otherwise the MCU 23 proceeds to step S261. In step S261, the MCU 23 substitutes “0” for the variable “m”. In step S263, the MCU 23 increments the variable “k” by one, and proceeds to step S233.

The processes of FIG. 19 are the processes for calculating the leftmost element number “X” (X-coordinate) of the array “Hc[X][k]” which stores “1” and the rightmost element number “X” (X-coordinate) of the array “Hc[X][k]” which stores “1”, in regard to the second potential area.

Referring to FIG. 20, in step S281 the MCU 23 substitutes “0” for the variable “r”, “n”, “m”, “k”, “Vmx[ ][ ]” and “Vmn[ ][ ]” respectively. In step S283, the MCU 23 substitutes a value of variable “Vn[n]” for the variable “Y”. In step S285, the MCU 23 proceeds to step S287 if a variable “Vc[Y][k]” is “1”, otherwise the MCU 23 proceeds to step S291. In step S287, the MCU 23 proceeds to step S289 if the variable “Vc[Y−1][k]” is “0”, otherwise the MCU 23 proceeds to step S297. In step S289, the MCU 23 substitutes a value of the variable “Y” for the variable “Vmn[r][k]”.

In step S291, the MCU 23 proceeds to step S293 if the variable “Vc[Y−1][k]” is “1”, otherwise the MCU 23 proceeds to step S297. In step S293, the MCU 23 substitutes a value of the variable “Y” for the variable “Vmx[r][k]”. In step S295, the MCU 23 increments the value of the variable “r” by one.

In step S297, the MCU 23 increments the value of the variable “Y” by one. In step S299, if a value of the variable “X” is equal to the value that added “1” to the value of the variable “Vx[n]”, the MCU 23 proceeds to step S301, otherwise the MCU 23 returns to step S285. In step S301, the MCU 23 substitutes the value that subtracted “1” from the value of the variable “r” for the variable “N[k]”.

In step S303, the MCU 23 substitutes “0” for the variable “r”. In step S305, if the value of the variable “m” is equal to the value of the variable “Hm”, the MCU 23 proceeds to step S309, otherwise the MCU 23 proceeds to step S307. In step S307, the MCU 23 increments each value of the variables “m” and “k” by one, and then returns to step S283. On the other hand, in step S309, the MCU23 proceeds to step S311 if the value of the variable “k” is equal to the value of the variable “K”, otherwise the MCU 23 proceeds to step S313. In step S313, the MCU 23 substitutes “0” for the variable “m”. In step S315, the MCU 23 increments the variables “k” and “n” by one respectively, and then proceeds to step S283.

In step S311, the MCU 23 substitutes the value of the variable “K” for the variable “J” and proceeds to step S331 of FIG. 21.

The processes of FIG. 20 are the processes for calculating the uppermost element number “Y” (Y-coordinate) of the array “Vc[Y][k]” which stores “1” and the lowermost element number “Y” (Y-coordinate) of the array “Vc[Y][k]” which stores “1”, in regard to the second potential area.

In this way, each first potential area is scanned, and the second potential area is determined (refer to FIG. 5B).

FIG. 24 is a flowchart showing the trigger detecting process (based on the sword) in step S9 of FIG. 14. Referring to FIG. 24, in step S441, the MCU 23 clears the trigger flag. The information indicating the kind of the trigger generated is set to a trigger flag. In step S443, the MCU 23 performs the detecting process for the shield trigger. In step S445, the MCU 23 performs the detecting process for the special trigger. In step S447, the MCU 23 performs the detecting process for the swing trigger.

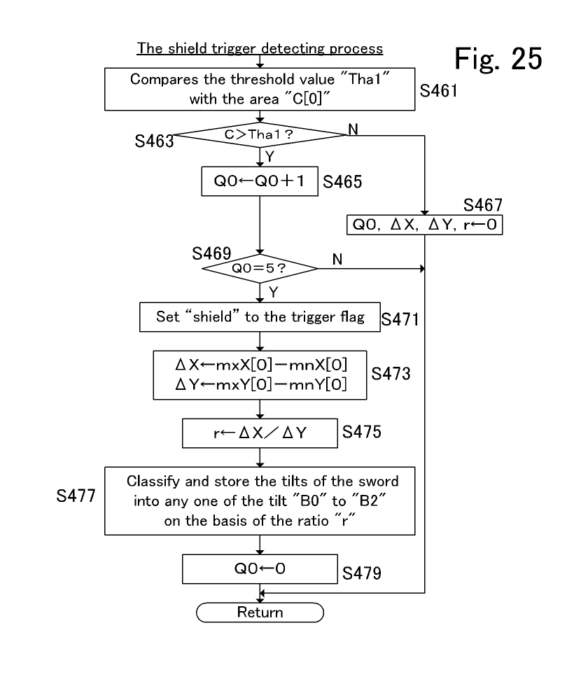

FIG. 25 is a flowchart showing the shield trigger detecting process in step S443 of FIG. 24.

Referring to FIG. 25, in step S461, the MCU 23 compares the threshold value “Tha1” with the area “C[0]” of the retroreflection sheet. In step S463, if the area “C[0]” is larger than the threshold value “Tha1”, the MCU 23 judges that the retroreflection sheet 4A was photographed, and then proceeds to step S465; otherwise the MCU 23 proceeds to step S467. In step S465, the MCU 23 increments the value of the variable “Q0” by one. In step S469, if the value of the variable “Q0” is equal to “5”, that is, if the retroreflection sheet 4A is photographed five successive times, the MCU 23 proceeds to step S471; otherwise the MCU 23 returns. On the other hand, in step S467, the MCU 23 substitutes “0” for each of the variables “Q0”, “ΔX”, “ΔY” and “r”, and then returns.

In step S471, the MCU 23 sets the value indicating the shield (the shield trigger occurs) to the trigger flag. In step S473, the MCU 23 substitutes “mxX[0]-mnX[0]” (in other words the length of the horizontal direction of the potential area) for the variable “ΔX”, and substitutes “mxY[0]-mnY[0]” (in other words the length of the vertical direction of the potential area) for the variable “ΔY”. In step S475, the MCU 23 calculates the ratio “r” by the next formula.

r←ΔX/ΔY

In step S477, the MCU 23 classifies the tilts of the sword 3A-N into any one of the tilt “B0” to “B2” on the basis of the ratio “r”, and stores the result. In step S479, the MCU23 substitutes “0” for the variable “Q0” and returns.

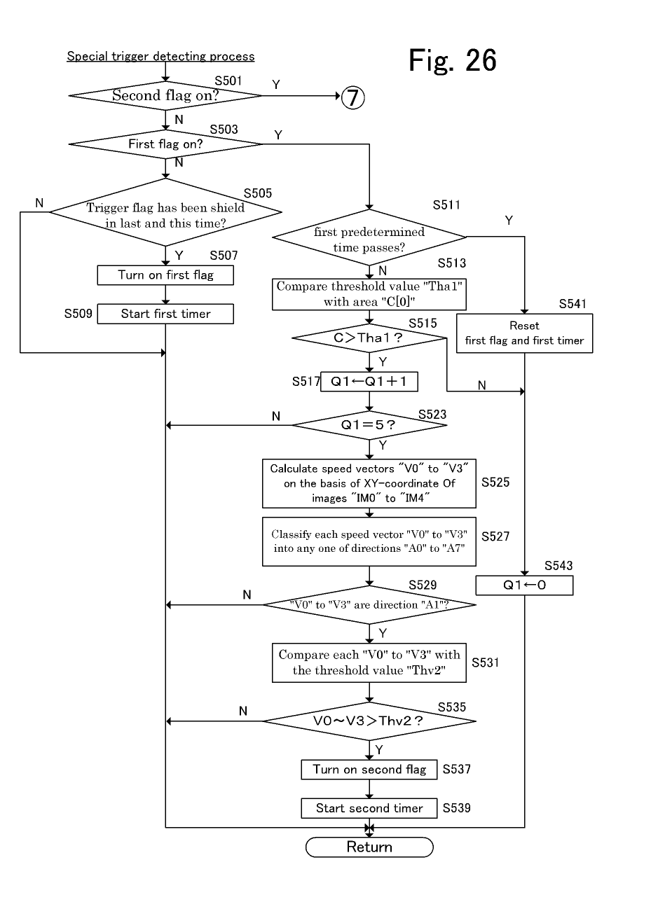

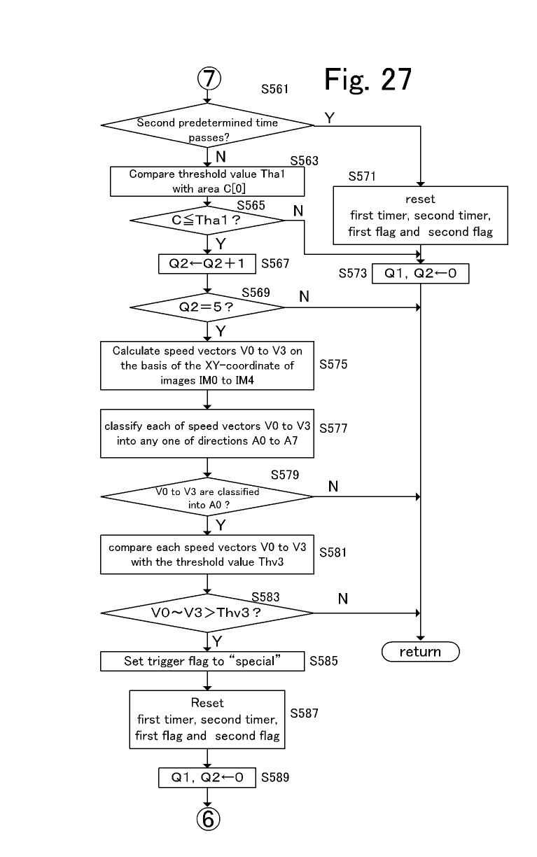

FIG. 26 and FIG. 27 are flowcharts showing the special trigger detecting process in step S445 of FIG. 24. Referring to FIG. 26, in step S501, if the second flag is on the second flag is on, the MCU 23 proceeds to step S561 of FIG. 27, and if the second flag is off, the MCU 23 proceeds to step S503. In step S503, If the first flag is on, the MCU 23 proceeds to step S511, and if the first flag is off, the MCU 23 proceeds to step S505.

In step S505, if the trigger flag has been set to the shield in last time and this time, the MCU 23 proceeds to step S507; otherwise the MCU 23 returns. In step S507, the MCU 23 turns on the first flag. In step S509, the MCU 23 starts the first timer and returns.

In step S511, the MCU 23 refers to the first timer, and if the first predetermined time passes, the MCU 23 proceeds to step S541; otherwise the MCU 23 proceeds to step S513. In step S513, the MCU 23 compares the threshold value “Tha1” with the area “C[0]” of the retroreflection sheet 4. In step S515, if the area “C[0]” is larger than the threshold value “Tha1”, the MCU 23 judges that the retroreflection sheet 4A was detected, and then proceeds to step S517; otherwise the MCU 23 proceeds to step S543.

In step S523, if the value of the variable “Q1” is equal to “5”, that is, if the retroreflection sheet 4A is detected in succession five times, the MCU 23 proceeds to step S525; otherwise, the MCU 23 returns. In step S525, the MCU 23 calculates the speed vectors “V0” to “V3” on the basis of the XY-coordinate (Xr, Yr) of the present and the past images “IM0” to “IM4” of the retroreflection sheets 4A. In step S527, the MCU 23 classifies each of the speed vectors “V0” to “V3” into any one of the directions “A0” to “A7”. In step S529, if all speed vectors “V0” to “V3” are classified into the same direction “A1”, the MCU 23 proceeds to step S531; otherwise the MCU 23 returns.

In step S531, the MCU 23 compares each size of the speed vectors “V0” to “V3” with the threshold value “Thv2”. In step S535, the size of all speed vectors “V0” to “V3” are bigger than the threshold value “Thv2”; otherwise the MCU 23 returns. In step S537, the MCU 23 turns on the second flag. In step S539, the MCU 23 starts the second timer and returns.

In step S541, the MCU 23 resets the first timer and the first flag. In step S543, the MCU23 substitutes “0” for the variable “Q1” and returns.

Referring to FIG. 27, In step S561, the MCU 23 refers to the second timer, and if the second predetermined time passes, the MCU 23 proceeds to step S571; otherwise the MCU 23 proceeds to step S563. In step S571, the MCU 23 resets the first timer, the second timer, the first flag and the second flag. In step S573, the MCU 23 substitutes “0” for each of the variables “Q1” and “Q2” and returns.

In step S569, if the value of the variable “Q2” is equal to “5”, the MCU 23 judges the retroreflection sheet 4B was detected five times in succession, and proceeds to step S575; otherwise the MCU 23 returns. In step S575, the MCU 23 calculates the speed vectors “V0” to “V3” on the basis of the XY-coordinate (Xr, Yr) of the present and the past four images “IM0” to “IM4” of the retroreflection sheet 4B. In step S577, the MCU 23 classifies each of the speed vectors “V0” to “V3” into any one of the directions “A0” to “A7”. In step S579, if all speed vectors “V0” to “V3” are classified into the same direction “A0”, the MCU 23 proceeds to step S581; otherwise the MCU 23 returns.

In step S569, if the value of the variable “Q2” is equal to “5”, the MCU 23 judges the retroreflection sheet 4B was detected five times in succession, and proceeds to step S575; otherwise the MCU 23 returns. In step S575, the MCU 23 calculates the speed vectors “V0” to “V3” on the basis of the XY-coordinate (Xr, Yr) of the present and the past four images “IM0” to “IM4” of the retroreflection sheet 4B. In step S577, the MCU 23 classifies each of the speed vectors “V0” to “V3” into any one of the directions “A0” to “A7”. In step S579, if all speed vectors “V0” to “V3” are classified into the same direction “A0”, the MCU 23 proceeds to step S581; otherwise the MCU 23 returns.

In step S581, the MCU 23 compares each size of the speed vectors “V0” to “V3” with the threshold value “Thv3”. In step S583, if the size of all speed vectors “V0” to “V3” are bigger than the threshold value “Thv3”, the MCU 23 proceeds to step S585, otherwise the MCU 23 returns. In step S585, the MCU 23 sets the trigger flag to the special (generation of the special trigger). In step S587, the MCU 23 resets the first timer, the second timer, the first flag and the second flag. In step S589, the MCU 23 substitutes “0” for each of the variables “Q1” and “Q2”, and the MCU 23 proceeds to step S11 of FIG. 14.

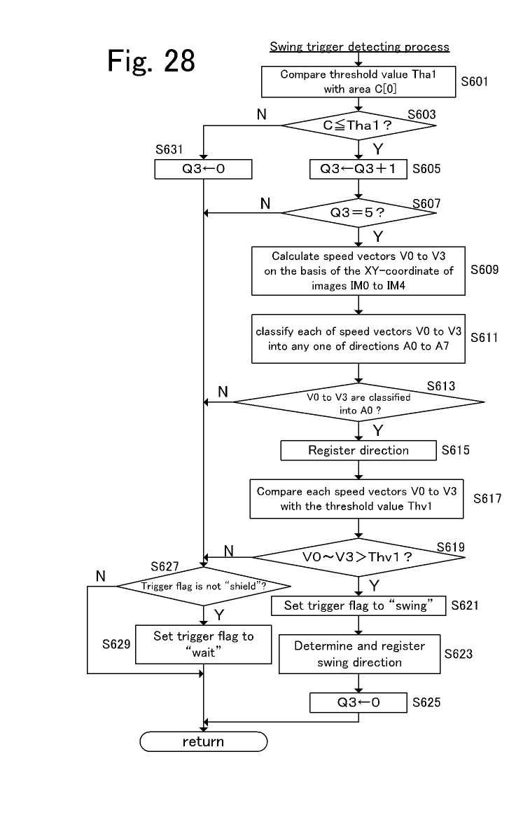

FIG. 28 is a flowchart showing the swing trigger detecting process in step S447 of FIG. 24. Referring to FIG. 28, in step S601, the MCU 23 compares the threshold value “Tha1” with the area “C[0]” of the retroreflection sheet. In step S603, if the area “C[0]” is not more than the threshold value “Tha1”, the MCU 23 judges the retroreflection sheet 4B was detected, and proceeds to step S605; otherwise the MCU 23 proceeds to step S631. In step S631, the MCU 23 substitutes “0” for the variable “Q3” and proceeds to step S627. In step S605, the MCU 23 increments the value of the variable “Q3” by one.

In step S607, if the value of the variable “Q3” is equal to “5”, the MCU 23 judges the retroreflection sheet 4B was photographed five times in succession, and proceeds to step S609; otherwise the MCU 23 proceeds to step S627. In step S609, the MCU 23 calculates the speed vectors “V0” to “V3” on the basis of the XY-coordinate (Xr, Yr) of the present and the past images “IM0” to “IM4” of the retroreflection sheet 4B. In step S611, the MCU 23 classifies each of the speed vectors “V0” to “V3” into one of the directions “A0” to “A7”. In step S613, if all speed vectors “V0” to “V3” are classified into the same direction, the MCU 23 proceeds to step S615; otherwise the MCU 23 proceeds to step S627.

In step S615, the MCU 23 registers (stores) the directions of the speed vectors “V0” to “V3”. In step S617, the MCU 23 compares each size of the speed vectors “V0” to “V3” with the threshold value “Thv1”. In step S619, if the size of all speed vectors “V0” to “V3” are bigger than the threshold value “Thv1”, the MCU 23 judges the sword 3A-N was swung, and proceeds to step S621; otherwise the MCU 23 proceeds to step S627. In step S621, the MCU 23 sets the trigger flag to the swing (generation of the swing trigger). In step S623, the MCU 23 calculates the swing position on the basis of the XY-coordinate of the central image IM2 of the five images “IM0” to “IM4”, and registers (stores) the result. In this case, as shown in FIG. 9A to FIG. 9H, the MCU23 classifies the swing positions into one of seven positions in regard to each swing direction “A0” to “A7”. In step S625, the MCU 23 substitutes “0” for the variable “Q3”.

In step S627, the MCU 23 proceeds to step S629 if the trigger flag is not set to the shield, and the MCU 23 returns if the trigger flag is set to the shield. In step S629, the MCU 23 sets the wait to the trigger flag and returns.

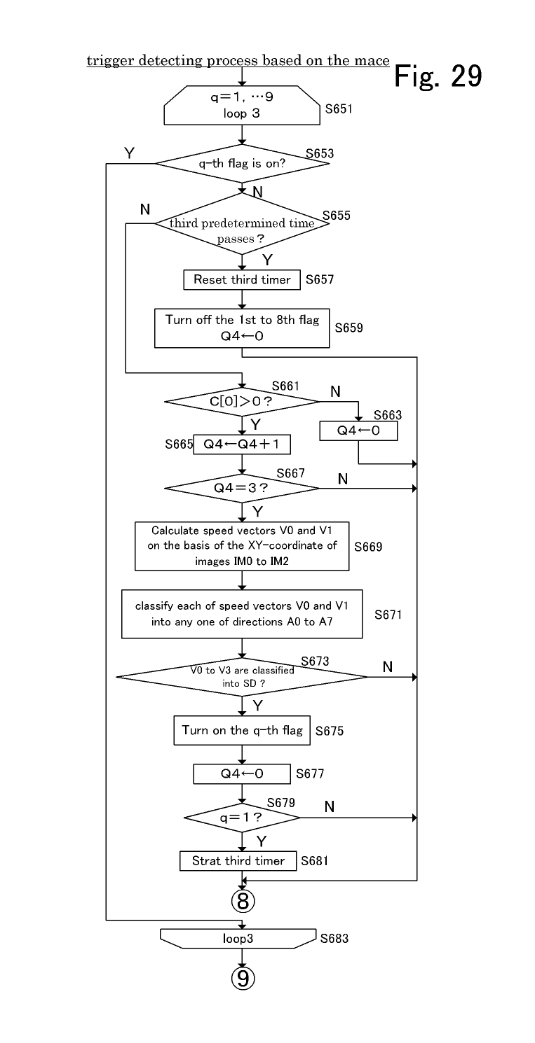

FIG. 29 and FIG. 39 are flowcharts showing the trigger detecting process (based on the mace 3B-N) in step S9 of FIG. 14. Referring to FIG. 29, the MCU 23 repeats step S651 to step S683, while updating the variable “q”. In step S653, the MCU23 proceeds to step S683 if the “q”-th flag is on, and the MCU 23 proceeds to step S655 if the “q”-th flag is off. In step S655, the MCU 23 refers to the third timer, and if the third predetermined time passes, the MCU 23 proceeds to step S657; otherwise the MCU 23 proceeds to step S661.

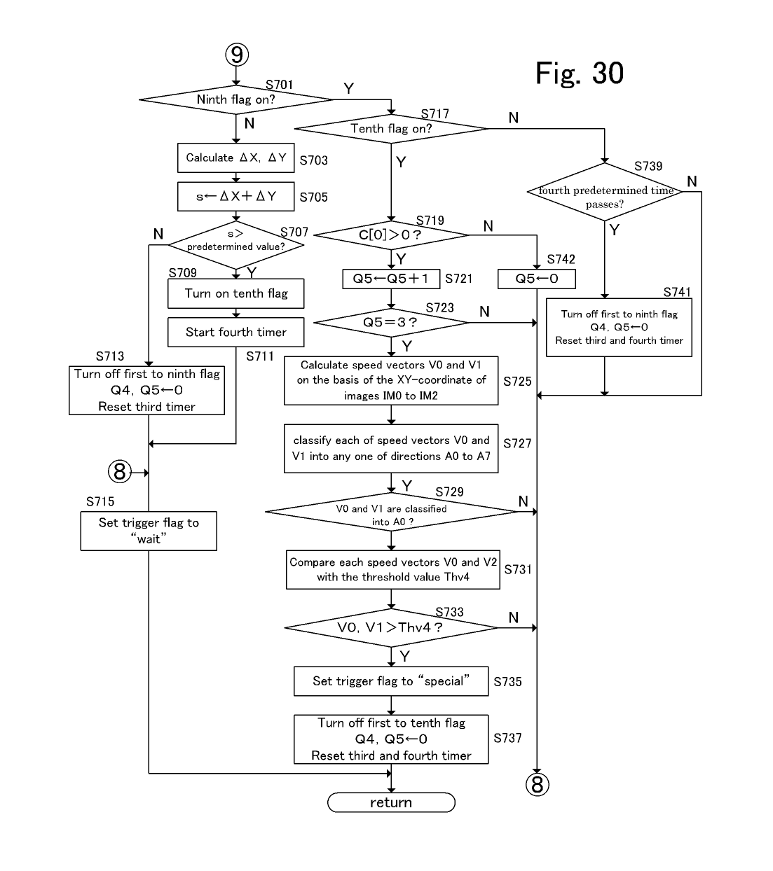

In step S657, the MCU 23 resets the third timer. In step S659, the MCU 23 turns off the first flag to the eighth flag, and substitutes “0” for the variable “Q4”, and then proceeds to step S715 of FIG. 30.

In step S661, if the area “C[0]” is bigger than “0”, that is, if the retroreflection sheet 4C is detected, the MCU 23 proceeds to step S665; otherwise the MCU 23 proceeds to step S663. In step S663, the MCU 23 substitutes “0” for the variable “Q4” and proceeds to step S715 of FIG. 30.

In step S665, the MCU 23 increments the variable “Q4” by one. In step S667, if the value of the variable “Q4” is equal to “3”, that is, if the retroreflection sheet 4C is detected three times in succession, the MCU 23 proceeds to step S669; otherwise, the MCU 23 proceeds to step S715 of FIG. 30.

In step S669, the MCU 23 calculates the speed vectors “V0” and “V2” on the basis of the XY-coordinate (Xr, Yr) of the present and the past two images “IM0” to “IM4” of the retroreflection sheet 4C. In step S671, the MCU 23 classifies each of the speed vectors “V0” and “V2” into one of the directions “A0” to “A7”. In step S673, if all speed vectors “V0” and “V1” are classified into the same direction “SD”, the MCU 23 proceeds to step S675; otherwise the MCU 23 proceeds to step S715 of FIG. 30.

Incidentally, in regard to each “q=1” to “q=9”, the direction “SD” is assigned in order of the directions “A2”, “A7”, “A0”, “A5”, “A3”, “A6”, “A1”, “A4” or “A2”.

In step S675, the MCU 23 turns on the “q”-th flag. In step S677, the MCU 23 substitutes “0” for the variable “Q4”. In step S679, if the value of the variable “q” is “1”, the MCU 23 proceeds to step S681 to start the third timer, otherwise the MCU 23 proceeds to step S715 of FIG. 30. In step S681, the MCU 23 starts the third timer and proceeds to step S715 of FIG. 30.

Referring to FIG. 30, in step S701, the MCU 23 proceeds to step S717 if the ninth flag is on, and the MCU 23 proceeds to step S703 if the ninth flag is off. In step S703, the MCU 23 calculates the difference “ΔX” between the largest coordinate “X1” and the smallest coordinate “X0” among the X-coordinates “Xr” of the nine images of the retroreflection sheet 4C which turns on the first flag to the ninth flag, and the MCU 23 calculates the difference “ΔY” between the largest coordinate “Y1” and the smallest coordinate “Y0” among the Y-coordinate “Yr” of such nine images (refer to FIG. 11A).

In step S705, the MCU 23 substitutes “ΔX+ΔY” for the variable “s”. In step S707, the MCU 23 proceeds to step S709 if the value of the variable “s” exceeds a predetermined value, otherwise the MCU 23 proceeds to step S713. In step S713, the MCU 23 turns off the first flag to the ninth flag, and substitutes “0” for each of the variables “Q4” and “Q5”, and resets the third timer.

In step S709, the MCU 23 turns on the tenth flag. In step S711, the MCU 23 starts the fourth timer and proceeds to step S715. In step S715, the MCU23 sets the trigger flag to the wait; and the MCU 23 returns.

In step S717, the MUC 23 proceeds to step S719 if the tenth flag is on, and the MCU 23 proceeds to step S739 if the tenth flag is off. In step S719, the MCU 23 compares the threshold value “Tha1” with the area “C[0]”. In step S565, if the area “C[0]” is bigger than “0”, that is, if the retroreflection sheet 4C is photographed, the MCU 23 proceeds to step S721; otherwise the MCU 23 proceeds to step S742. In step S742, the MCU 23 substitutes “0” for the variable “Q5”. On the other hand, in step S721, the MCU 23 increments the value of the variable “Q5” by one.

In step S723, if the value of the variable “Q5” is equal to “3”, that is, if the retroreflection sheet 4C is detected three times in succession, the MCU 23 proceeds to step S725; otherwise, the MCU 23 proceeds to step S715. In step S725, the MCU 23 calculates the speed vectors “V0” and “V2” on the basis of the XY-coordinate (Xr, Yr) of the present and the past two images “IM0” to “IM4” of the retroreflection sheet 4C. In step S727, the MCU 23 classifies each of the speed vectors “V0” and “V1” into one of the directions “A0” to “A7”. In step S729, if all speed vectors “V0” and “V1” are classified into the same direction “A0”, the MCU 23 proceeds to step S731; otherwise the MCU 23 proceeds to step S715.

In step S731, the MCU 23 compares each size of the speed vectors “V0” and “V1” with the threshold value “Thv4”. In step S733, the MCU 23 proceeds to step S735 if sizes of all speed vectors “V0” and “V1” are larger than the threshold value “Thv4”, otherwise the MCU 23 proceeds to step S715. In step S735, the MCU 23 sets the trigger flag to the special (generation of the special trigger).

In step S737, the MCU 23 turns off the first flag to the tenth flag, and substitutes “0” for each of the variables “Q4” and “Q5”, and resets the third and fourth timer, and returns.

In step S739, the MCU 23 refers to the fourth timer, and if the fourth predetermined time passes, the MCU 23 proceeds to step S741; otherwise the MCU 23 proceeds to step S715. In step S741, the MCU 23 turns off the first flag to the ninth flag, and substitutes “0” for each of the variables “Q4” and “Q5”, and resets the third and fourth timer, and proceeds to step S715.

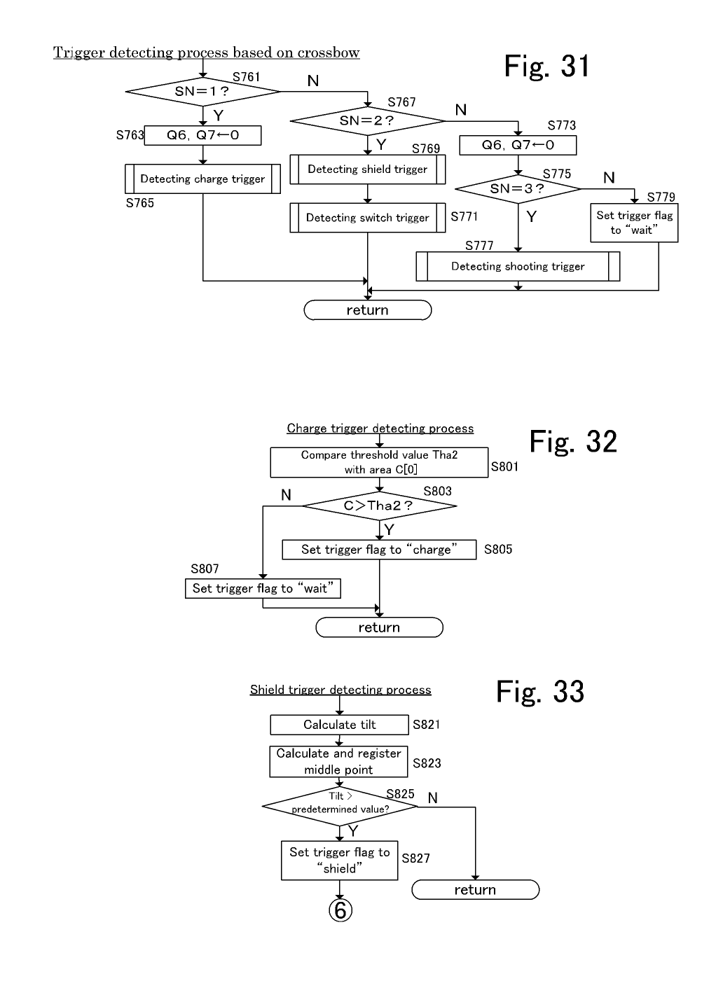

FIG. 31 is a flowchart showing the trigger detecting process (based on the crossbow 3C-N) in step S9 of FIG. 14. Referring to FIG. 31, in step S761, if the value of the variable “SN” indicating the number of the retroreflection sheet which appears in the differential image is “1”, the MCU 23 judges that there is a possibility that the retroreflection sheet 4G was photographed, and proceeds to step S763; otherwise the MCU 23 proceeds to step S767. In step S763, the MCU 23 substitutes “0” for each of the variables “Q6” and “Q7” to be described below. In step S765, the MCU 23 performs the detecting process for the charge trigger and returns.

In step S767, if the value of the variable “SN” is “2”, the MCU 23 judges that the retroreflection sheets 4E and 4F were photographed, and proceeds to step S769; otherwise the MCU 23 proceeds to step S773. In step S769, the MCU 23 performs the detecting process for the shield trigger. In step S771, the MCU 23 performs the detecting process for the switch trigger and returns.

In step S773, the MCU 23 substitutes “0” for the variables “Q6” and “Q7” respectively. In step S775, if the value of the variable “SN” is “3”, the MCU 23 judges that the retroreflection sheets 4D, 4E and 4F were photographed, and proceeds to step S777; otherwise the MCU 23 proceeds to step S779. In step S777, the MCU 23 performs the detecting process for the shooting trigger and returns. In step S779, the MCU 23 sets the trigger flag to the wait and returns.

FIG. 32 is a flowchart showing the charge trigger detecting process in step S765 of FIG. 31. Referring to FIG. 32, in step S801, the MCU 23 compares the threshold value “Tha2” with the area “C[0]” of the retroreflection sheet. In step S803, if the area “C[0]” is larger than “Tha2”, the MCU 23 judges that the retroreflection sheet 4G was photographed and proceeds to step S805; otherwise the MCU 23 proceeds to step S807. In step S805, the MCU 23 sets the trigger flag to the charge (generation of the charge trigger) and returns. In step S807, the MCU 23 sets the trigger flag to the wait and returns.

FIG. 33 is a flowchart showing the shield trigger detecting process in step 769 of FIG. 31. Referring to FIG. 33, in step S821, the MCU 23 judges that the retroreflection sheets 4E and 4F were photographed, and calculates the tilt “T1” of the straight line which bind those XY-coordinates (Xr, Yr). In step S823, the MCU 23 calculates the middle point of those XY coordinates (Xr, Yr) and registers (stores) the result. In step S825, the MCU 23 proceeds to step S827 if the tilt “T1” is larger than a certain value, otherwise the MCU 23 returns. In step S827, the MCU 23 sets the trigger flag to the shield (generation of the shield trigger) and proceeds to step S11 of FIG. 14.

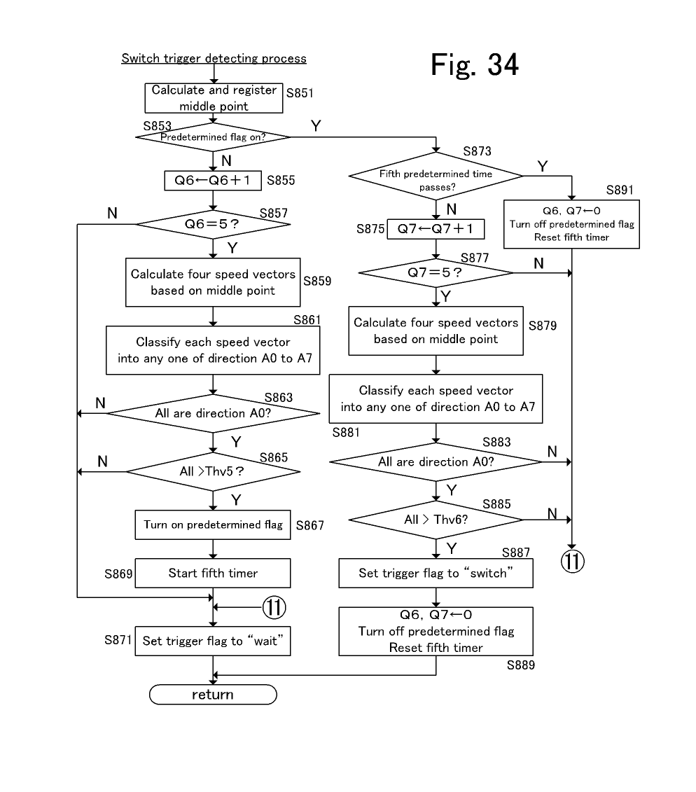

FIG. 34 is a flowchart showing the switch trigger detecting process in step 771 of FIG. 31.

Referring to FIG. 34, the MCU 23 judges that the retroreflection sheets 4E and 4F were photographed, and calculates the middle point of those XY-coordinates (Xr, Yr), and registers (stores) the result. When a predetermined flag is on, in step S853, MCU23 advances in step S873 and, in the case of off, advances to step S855.

In step S855, the MCU 23 increments the value of the variable “Q6” by one. In step S857, the MCU23 proceeds to step S859 if the variable “Q6” is “5”, otherwise the MCU 23 proceeds to step S871. In step S859, the MCU 23 calculates four speed vectors based on the middle point which the MCU 23 calculated in step S851. In step S861, MCU23 classifies each of the four speed vectors in any one of directions “A0” to “A7”. In step S863, the MCU 23 proceeds to step S865 if all speed vectors are classified into the direction “A1”, otherwise the MCU 23 proceeds to step S871.

In step S865, the MCU 23 proceeds to step S867 if the sizes of all speed vectors are larger than the threshold value “Thv5”, otherwise the MCU 23 proceeds to step S871. In step S867, the MCU 23 turns on the predetermined flag. In step S869, the MCU 23 starts the fifth timer and proceeds to step S871. In step S871, the MCU 23 sets the trigger flag to the wait and returns.

In step S873, the MCU 23 refers to the fifth timer, and if the fifth predetermined time passes, the MCU 23 proceeds to step S891; otherwise the MCU 23 proceeds to step S875. In step S891, the MCU 23 substitutes “0” for each of the variables “Q6” and “Q7”, and turns off the predetermined flag, and resets the fifth timer, and proceeds to step S871.

In step S875, the MCU 23 increments the value of the variable “Q7” by one. In step S877, the MCU23 proceeds to step S879 if the variable “Q7” is “5”, otherwise the MCU 23 proceeds to step S871. In step S879, the MCU 23 calculates four of the speed vectors based on the middle point which the MCU 23 calculated in step S851. In step S881, the MCU 23 classifies each of the four speed vectors into one of the directions “A0” to “A7”. In step S863, the MCU 23 proceeds to step S865 if all speed vectors are classified into the direction “A0”, otherwise the MCU 23 proceeds to step S871. In step S885, the MCU 23 proceeds to step S887 if the sizes of all speed vectors are larger than the threshold value “Thv6”, otherwise the MCU 23 proceeds to step S871. In step S887, the MCU 23 sets the trigger flag to the switch (generation of the switch trigger). In step S889, the MCU 23 substitutes “0” for each of the variables “Q6” and “Q7”, and turns off the predetermined flag, and resets the fifth timer, and returns.

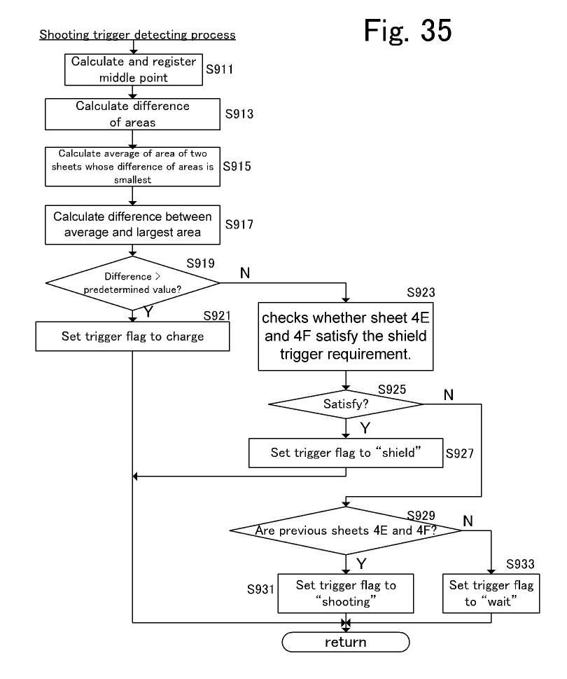

FIG. 35 is a flowchart showing the shooting trigger detecting process in step S777 of FIG. 31. Referring to FIG. 35, in step S911, the MCU 23 calculates the coordinates of the center of the retroreflection sheets 4E and 4F, and registers (stores) the result. In step S913 the MCU 23 calculates the difference value “|C[0]−C[1]|”, “|C[1]−C[2]|” and “|C[2]−C[0]|”; “C[0]”, “C[1]” and “C[2]” are area of the three retroreflection sheets 4D, 4E and 4F.

In step S915, the MCU 23 calculates the average value of the areas of the two retroreflection sheets whose difference value is the smallest. In step S917, the MCU 23 calculates the difference between the average value which the MCU 23 calculated in step S915 and the area value of the retroreflection sheet which has the largest area value. In step S919, if the difference which the MCU 23 calculated in step S917 is larger than a predetermined value, the MCU 23 judges that the retroreflection sheet whose area value is largest is the retroreflection sheet 4G, and the MCU 23 proceeds to step S921; otherwise, the MCU 23 proceeds to step S923. In step S921, the MCU 23 sets the trigger flag to the charge (generation of the charge trigger) and returns. In step S923, the MCU 23 checks whether the retroreflection sheet 4E and 4F satisfy the shield trigger requirements.

In step S925, if the shield trigger requirements are satisfied, the MCU 23 proceeds to step S927, otherwise the MCU 23 proceeds to step S929. In step S927, the MCU 23 sets the trigger flag to the shield and returns (generation of the shield trigger).

In step S929, if two retroreflection sheet detected in the last time are the retroreflection sheets 4E and 4F, the MCU 23 proceeds to step S929; otherwise the MCU 23 proceeds to step S933. In step S931, the MCU 23 sets the trigger flag to the shooting and returns (generation of the shooting trigger). In step S933, the MCU 23 sets the trigger flag to the wait, and returns.

In this way, in the present embodiment, what the camera unit 1-N transmits to the terminal 5-N is not the photographed image, but the analysis result of the photographed image as the input information by the operation article 3-N (the state information of the operation article (the retroreflection sheets 4)), that is, the input information by a user. Therefore, when a game programmer uses the camera unit 1-N as an input device, he does not have to make a program for analyzing the photographed image, and he can treat the camera unit 1-N like general input devices, e.g. keyboard etc. As a result, the camera unit 1 becomes easy for game programmer to use as an input device. Furthermore, it is possible to provide in an easy way an online game using a dynamic motion, for example a motion of an operation article 3-N in three dimension space, as an input. (motion-sensing online game)

In addition, the camera unit 1-N gives to the terminal 5-N the state information of the operation article 3-N, that is the retroreflection sheet 4. The state information is, for example, the XY-coordinate (Xr, Yr) or the area information. Therefore, the terminal 5-N can execute process based on the state information of the operation article 3-N. For example, the terminal 5 displays a cursor in monitor 7 at the position corresponding to the XY-coordinate (Xr, Yr) of the operation article 3-N.

Furthermore, camera unit 1-N gives the state information of the operation article 3-N (the retroreflection sheet 4) to the terminal 5-N as command. Therefore, the terminal 5-N can execute the process based on the command corresponding to the state information of the operation article 3-N. For example, the commands from the camera unit 1 to the terminal 5 are the swing trigger (the movement information), the shield trigger (the area information of the sword 3A-N, the placement information of the crossbow 3C-N), the special trigger (the area information or the movement information of the sword 3A-N, the move information of the mace 3B-N), the charge trigger (area information), the switch trigger (the movement information) and the shooting trigger (the number information).

For example, the terminal 5-N displays a trace of a sword to the monitor 7 depending on the swing trigger. For example, the terminal 5-N displays a shield image to the monitor 7 depending on the shield trigger. For example, the terminal 5-N displays a first predetermined effect to the monitor 7 depending on the special trigger by the sword 3A-N. For example, the terminal 5-N displays a second predetermined effect to the monitor 7 depending on the special trigger by the mace 3A-N. For example, the terminal 5-N charges energy of a game character depending on the charge trigger. For example, the terminal 5-N changes the fire-mode (e.g. rapid-fire mode or single-shot mode) of the arrow depending on the switch trigger. For example, the terminal 5-N displays an arrow fired on monitor 7 depending on the shooting trigger.

In addition, in the present embodiment, it is possible to calculate the state information even though the number of the retroreflection sheets 4 exceeds three, on the other hand, in the case where the number of the retroreflection sheets 4 is one or two, it is possible to skip the processes of FIG. 18 to FIG. 20 (the processes for determining the second potential area), that is, it is possible to reduce processing load.

### INDUSTRIAL APPLICABILITY

It is available for user-interface. For example, it is available for the video game which treat human physical movement as input.

Meanwhile, the present invention is not limited to the above embodiments, and a variety of variations and modifications may be effected without departing from the spirit and scope thereof, as described in the following exemplary modifications.

(1) In the above description, the camera unit 1 is used for the online game, however, the camera unit can be used also for offline game, i.e. standalone video game.

(2) In the above description, the online game is performed through the host computer 31, however, it is also possible to perform the online game, by transmitting/receiving the state information directly between the terminals 5-N without the host computer 31.

(3) In the above description, the shutter 49 of the crossbow 3C-N is configured to open when a player pulls the trigger 51. However, the shutter 49 may be configured to open when a player does not pull the trigger 51 and to close when a player pulls the trigger 51.

(4) An operation article may be configured to include: a first retroreflection sheet and a second retroreflection sheet; and a switching unit which switches the state of the first retroreflection sheet and the second retroreflection sheet so that exposure state and non-exposure state become opposite state by and between the first retroreflection sheet and the second retroreflection sheet.

In this case, exposure state and non-exposure state of the first retroreflection sheet and the second retroreflection sheet become opposite each other, so it is possible to detect the input and/or the input type from the operation article, on the basis of the photographed images of each retroreflection sheet.

In addition, based on the switch of exposure and non-exposure between the first retroreflection sheet and the second retroreflection sheet, it is possible to detect the input and/or the input type from the operation article.

(5) In the above description, to detect the retroreflection sheet 4, the MCU 23 uses the stroboscope (blinking of infrared emitting diodes 11) and generates the differential image “DI”. However, it is just an suitable example, it is not an indispensable element for this invention. In other words the infrared emitting diodes 11 may be configured not to blink, and the infrared emitting diodes 11 may be omitted. The light emitted is not limited to infrared light. In addition, retroreflection sheet 4 is not indispensable element for this invention, other units or methods are available if they can analyze images and detect the operation article 3-N. Image sensing device is not limited to the image sensor. Other devices are available, for example CCD.

While the present invention has been described in terms of embodiments, those skilled in the art will recognize that the invention is not limited to the embodiments described. The present invention can be practiced with modification and alteration within the spirit and scope of the appended claims.

1. An imaging apparatus disposed separately from a computer, comprising:
an imaging unit operable to photograph an operation article operated by a user;
an detecting unit operable to analyze a photographed image given from the imaging unit, detect an input from the operation article, and generate an input information; and
an transmitting unit operable to transmit the input information to the computer.

2. The imaging apparatus as claimed in claim 1, wherein the detecting unit analyzes the photographed image, calculates state information of the operation article, and gives the transmitting unit the state information as the input information.

3. The imaging apparatus as claimed in claim 2, wherein the state information of the operation article means position information, speed information, movement direction information, movement distance information, speed vector information, acceleration information, movement locus information, area information, tilt information, movement information, form information or an combination thereof.

4. The imaging apparatus as claimed in claim 2, wherein the state information of the operation article is the state information of one or a plurality of markers attached to the operation article.

5. The imaging apparatus as claimed in claim 2, wherein the transmitting unit transmits the state information as a command to the computer.

6. The imaging apparatus as claimed in claim 1, further comprising: a stroboscope operable to emit light at predetermined intervals, wherein the imaging unit photographs the operation article each in an emitting period and an non-emitting period of the stroboscope, and further comprising a differential signal generating unit operable to get the images of both of the emitting period and the non-emitting period, and generate a differential signal.

7. The imaging apparatus as claimed in claim 1, wherein the operation article includes a retroreflection unit which retro-reflects the light received.

8. The imaging apparatus as claimed in claim 4, wherein the detecting unit comprising:
a first potential area determining unit operable to determine, from the photographed image by the imaging unit, a first potential area which includes the image of the marker and is comprised of fewer pixels than the pixels of the photographed image;
a first state calculating unit operable to scan the first potential area and calculate the state information of the marker, in the case where the number of the marker is one or two;
a second potential area determining unit operable to determine, from the first potential area, a second potential area which includes the image of the marker and is comprised of fewer pixels than the pixels of the first potential area, in the case where the number of the marker is at least three; and
a second state information calculating unit operable to scan the second potential area and calculate the state information of the marker, in the case where the number of the marker is at least three.

9. An online-game system, comprising a plurality of imaging apparatus each of which is connected to a corresponding terminal and is disposed separately from the terminal,
and wherein the imaging apparatus, comprising:
an imaging unit operable to photograph an operation article operated by a user;
an detecting unit operable to analyze a photographed image given from the imaging unit, detect an input from the operation article, and generate an input information; and a transmitting unit operable to transmit the input information to the terminal,
and wherein a plurality of the terminals are connected each other via a network, and perform game by exchanging the input information each other.

10. An operation article which is a subject of the imaging apparatus and is held and moved by a user, comprising:
a plurality of retroreflection units; and
a switching unit operable to switch an exposure state and a non-exposure state in regard to at least one of the retroreflection sheets, and wherein at least one of the retroreflection sheets keep the exposure state.

11. An operation article which is a subject of the imaging apparatus and is held and moved by a user, comprising:
a first reflection unit;
a second reflection unit; and
a switching unit operable to switch states of the first reflection unit and the second reflection unit so that an exposure state and non-exposure state become opposite state by and between the first reflection unit and the second reflection unit.

12. The operation article as claimed in claim 10, wherein the reflection unit retroreflects light received.

13. An input method performed by an imaging apparatus which is disposed separately from a computer, comprising the steps of:
photographing an operation article which is operated by a user;
analyzing an image which is given by the step of photographing, and detecting input from the operation article, and generating input information; and
transmitting the input information to the computer.

14. A computer-readable recording medium recording a computer program which makes a computer of the imaging apparatus execute the input method of claim 13.

15. An image analyzing apparatus, comprising:
an imaging unit operable to photograph one or a plurality of subjects;
a first potential area determining unit operable to determine, from the photographed image by the imaging unit, a first potential area which includes image of the subject and is comprised of fewer pixels than pixels of the photographed image;
a first state calculating unit operable to scan the first potential area and calculate the state information of the subject, in the case where the number of the subject is one or two;
a second potential area determining unit operable to determine, from the first potential area, a second potential area which includes the image of the subject and is comprised of fewer pixels than pixels of the first potential area, in the case where the number of the subject is at least three; and
a second potential area determining unit operable to scan the second potential area and calculate the state information of the subject, in the case where the number of the subject is at least three.

16. The image analyzing apparatus as claimed in claim 15,
wherein the first potential area determining unit comprising:
a first arranging unit operable to generate a first array which is the orthographic projection to the horizontal axis of a pixel value of the image;
a second arranging unit operable to generate a second array which is the orthographic projection to the vertical axis of the pixel value of the image; and
an unit operable to determine the first potential area based on the first array and the second array,
and wherein the second potential area determining unit comprising:
a third arranging unit operable to generate a third array which is the orthographic projection to the horizontal axis of the pixel value of the first potential area;
a fourth arranging unit operable to generate a fourth array which is the orthographic projection to the vertical axis of the pixel value of the first potential area; and
a unit operable to determine the second potential area based on the third array and the fourth array.

17. The image analyzing apparatus as claimed in claim 15, further comprising a stroboscope operable to emit light to the operation article at predetermined intervals,
wherein the imaging unit comprises a differential signal generating unit operable to photograph the operation article each in an emitting period and an non-emitting period of the stroboscope and get the images of both of the emitting period and the non-emitting period, and generate a differential signal,
and wherein the first potential area determining unit, the first state information calculating unit, the second potential area determining unit and the second state information calculating unit perform processes on the basis of the differential signal.

18. An image analyzing method is based on a photographed image given by an imaging unit photographing one or a plurality of subjects, comprising the steps of:
detecting, from the photographed image, a first potential area which includes image of the subject and is comprised of fewer pixels than pixels of the photographed image;
scanning the first potential area and calculating a state information of the subject, in the case where the number of the subject is one or two;
detecting, from the first potential area, a second potential area which includes the image of the subject and is comprised of fewer pixels than pixels of the first potential area, in the case where the number of the subject is at least three; and
scanning the second potential area and calculating the state information of the subject, in the case where the number of the subject is at least three.

19. A computer-readable recording medium recording a computer program which makes a computer perform the image analyzing method as claimed in claim 18.
